(19) United States
(12) Patent Application Publication
(10) Pub. No.: US 2026/0100170 A1
(43) Pub. Date: Apr. 9, 2026

(54) DISPLAY DEVICE

(71) Applicant: E Ink Holdings Inc., Hsinchu (TW)

(72) Inventors: Wen-Yu Kuo, Hsinchu (TW); Wen Ya Chao, Hsinchu (TW); Wen-Chuan Wang, Hsinchu (TW); Kuang-Heng Liang, Hsinchu (TW)

(73) Assignee: E Ink Holdings Inc., Hsinchu (TW)

(21) Appl. No.: 19/417,347

(22) Filed: Dec. 12, 2025

Related U.S. Application Data
(63) Continuation-in-part of application No. 18/979,684, filed on Dec. 13, 2024.
Application No. 18/979,684 is a continuation-in-part of application No. 18/474,229, filed on Sep. 26, 2023, now abandoned.
(60) Provisional application No. 63/774,111, filed on Mar. 19, 2025.

(30) Foreign Application Priority Data
Dec. 1, 2022 (TW) 111146117

(51) Int. Cl. G09G 3/34; G02F 1/167; G02F 1/16756; G02F 1/16766; G02F 1/1685

(52) U.S. Cl. CPC G09G 3/344; G02F 1/167; G02F 1/16756; G02F 1/16766; G02F 1/1685; G09G 2310/0267; G09G 2310/0275

(57) ABSTRACT

A display device includes a pixel array and a driving circuit. The pixel array includes a plurality of pixel units. The driving circuit is coupled to the pixel units through a plurality of scan signal lines and a plurality of data signal lines. Each of the pixel units includes a first transistor, a second transistor, a third transistor, an equivalent bootstrap capacitor, and an equivalent pixel capacitor. The first transistor is coupled to a first node. The second transistor is coupled to a second node. The third transistor is coupled to the second node. The equivalent bootstrap capacitor is coupled between the first node and the second node. The equivalent pixel capacitor is coupled between the first node and a reference voltage.

### CROSS-REFERENCE TO RELATED APPLICATION

This application is a continuation-in-part application of and claims the priority benefit of U.S. application Ser. No. 18/979,684, filed on Dec. 13, 2024, which is a continuation-in-part application of and claims the priority benefit of U.S. application Ser. No. 18/474,229, filed on Sep. 26, 2023, which claims the priority benefit of Taiwanese application no. 111146117, filed on Dec. 1, 2022. This application also claims the priority benefit of U.S. Provisional application Ser. No. 63/774,111, filed on Mar. 19, 2025. The entirety of each of the above-mentioned patent applications is hereby incorporated by reference herein and made a part of this specification.

### BACKGROUND

### Technical Field

The disclosure relates to a device, and more particularly, relates to a display device exhibiting good driving capability and requiring lower power consumption.

### Description of Related Art

In an electronic paper display module, the driving voltage is higher than that of a conventional liquid-crystal display (LCD) module or an organic light-emitting diode (OLED) display module. Therefore, for an electronic paper display module displaying black and white images, a data voltage of, for example, approximately −15 volts (V) to +15 volts, and a scan voltage of, for example, approximately −22 volts to +20 volts are required for data voltage writing and potential retention of the electrophoretic units. Further, for a color electronic paper display module, the required voltage is higher, where the data voltage is, for example, approximately −30 volts to +30 volts, and the scan voltage is, for example, approximately −48 volts to +48 volts. In comparison, the data driving voltage of a conventional LCD is approximately −6 volts to +6 volts. An OLED display module typically only requires a data driving voltage of 3 volts to 6 volts. In other words, the design complexity of the driving chip and system of the electronic paper display module increases, and the power consumption of the electronic paper display module when rendering images is also greater.

### SUMMARY

The disclosure provides a display device capable of achieving good driving capability and requiring lower power consumption.

The disclosure provides a display device including a pixel array and a driving circuit. The pixel array includes a plurality of pixel units. The driving circuit is coupled to the pixel units through a plurality of scan signal lines and a plurality of data signal lines. Each of the pixel units includes a first transistor, a second transistor, a third transistor, an equivalent bootstrap capacitor, and an equivalent pixel capacitor. The first transistor is coupled to a first node. The second transistor is coupled to a second node. The third transistor is coupled to the second node. The equivalent bootstrap capacitor is coupled between the first node and the second node. The equivalent pixel capacitor is coupled between the first node and a reference voltage.

To sum up, in the display device of the disclosure, the voltage value on the first node (i.e., the node outputting to the pixel units) can be increased according to different scan signals through the equivalent bootstrap capacitor coupled between different scan transistors. Further, the voltage value or current value of each scan signal (i.e., the driving signal) can be reduced, so that power consumption is lowered.

To make the above features and advantages of the disclosure more comprehensible, embodiments are specifically described below in detail with reference to the accompanying drawings as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic diagram of a display device according to an embodiment of the disclosure.

FIG. 2 is a circuit schematic diagram of a pixel unit according to an embodiment of the disclosure.

FIG. 3 is a waveform graph of a plurality of signals according to an embodiment of the disclosure.

FIG. 4 is a waveform graph of a plurality of signals according to an embodiment of the disclosure.

FIG. 5 is a circuit schematic diagram of a pixel unit according to an embodiment of the disclosure.

FIG. 6 is a structural cross-sectional view of a pixel unit according to an embodiment of the disclosure.

FIG. 7 is a structural cross-sectional view of a pixel unit according to an embodiment of the disclosure.

FIG. 8 is a layout diagram of a pixel unit according to an embodiment of the disclosure.

FIG. 9 is a structural cross-sectional view of a pixel unit according to an embodiment of the disclosure.

FIG. 10 is a structural cross-sectional view of a pixel unit according to an embodiment of the disclosure.

FIG. 11 is a layout diagram of a pixel unit according to an embodiment of the disclosure.

FIG. 12 is a layout diagram of a pixel unit according to an embodiment of the disclosure.

FIG. 13 is a structural cross-sectional view of a pixel unit according to an embodiment of the disclosure.

FIG. 14 is a structural cross-sectional view of a pixel unit according to an embodiment of the disclosure.

FIG. 15 is a layout diagram of a pixel unit according to an embodiment of the disclosure.

FIG. 16 is a layout diagram of a pixel unit according to an embodiment of the disclosure.

FIG. 17 is a layout diagram of a pixel unit according to an embodiment of the disclosure.

FIG. 18 is a layout diagram of a pixel unit according to an embodiment of the disclosure.

FIG. 19 is a circuit schematic diagram of a display device according to an embodiment of the disclosure.

FIG. 20 is a waveform graph of a plurality of signals according to an embodiment of the disclosure.

FIG. 21 is a circuit schematic diagram of a display device according to an embodiment of the disclosure.

FIG. 22 is a waveform graph of a plurality of signals according to an embodiment of the disclosure.

FIG. 23 is a circuit schematic diagram of a display device according to an embodiment of the disclosure.

FIG. 24 is a circuit schematic diagram of a display device according to an embodiment of the disclosure.

FIG. 25 is a circuit schematic diagram of a display device according to an embodiment of the disclosure.

FIG. 26 is a circuit schematic diagram of a display device according to an embodiment of the disclosure.

FIG. 27 is a circuit schematic diagram of a display device according to an embodiment of the disclosure.

FIG. 28 is a circuit schematic diagram of a display device according to an embodiment of the disclosure.

FIG. 29 is a circuit schematic diagram of a display device according to an embodiment of the disclosure.

FIG. 30 is a circuit schematic diagram of a display device according to an embodiment of the disclosure.

FIG. 31 is a waveform graph of a plurality of signals according to an embodiment of the disclosure.

FIG. 32 is a waveform graph of a plurality of signals according to an embodiment of the disclosure.

FIG. 33 is a circuit schematic diagram of a display device according to an embodiment of the disclosure.

FIG. 34 is a circuit schematic diagram of a bidirectional circuit according to an embodiment of the disclosure.

FIG. 35 is a waveform graph of a plurality of signals according to an embodiment of the disclosure.

FIG. 36 is a waveform graph of a plurality of signals according to an embodiment of the disclosure.

FIG. 37 is a waveform graph of a plurality of signals according to an embodiment of the disclosure.

FIG. 38 is a waveform graph of a plurality of signals according to an embodiment of the disclosure.

### DESCRIPTION OF THE EMBODIMENTS

Some embodiments of the disclosure will be described in detail with reference to the accompanying drawings. The reference numerals cited in the following description, when the same reference numerals appear in different drawings, will be regarded as the same or similar elements. These embodiments are only a part of the disclosure and do not disclose all possible implementations of the disclosure. More precisely, these embodiments are only examples within the scope of the patent application of the disclosure.

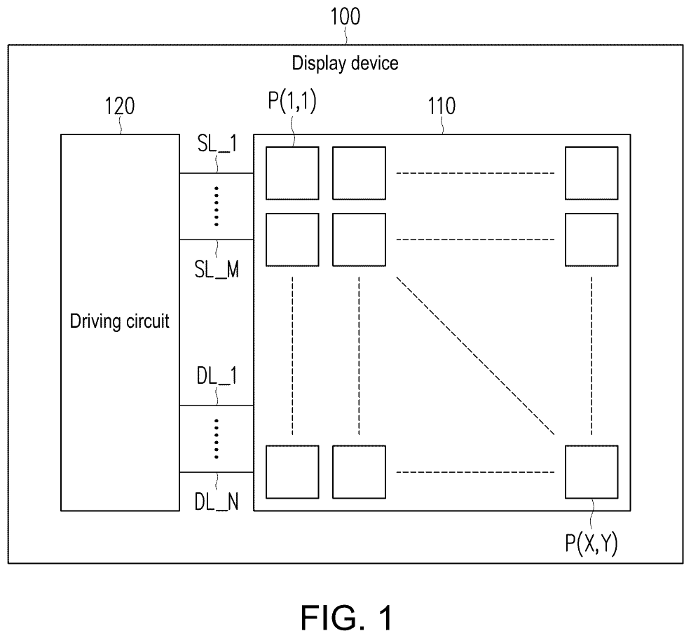

FIG. 1 is a schematic diagram of a display device according to an embodiment of the disclosure. Referring to FIG. 1, a display device 100 includes a pixel array 110 and a driving circuit 120. The pixel array 110 includes a plurality of pixel units P(1,1) to P(X,Y), where X and Y are both positive integers. The display device 100 further includes a substrate, and the pixel array 110 is formed on the substrate. The substrate may be, for example, a glass substrate, a silicon substrate, or a related semiconductor material substrate. The driving circuit 120 is coupled to the pixel units P(1,1) to P(M,N) through a plurality of scan signal lines SL_1 to SL_M and a plurality of data signal lines DL_1 to DL_N, where M and N are both positive integers. In this embodiment, the display device 100 may be an e-paper display. The pixel units P(1,1) to P(X,Y) may include microcapsule units or microcup units, where the aforementioned units may have electrophoretic particles of two colors, such as white electrophoretic particles and black electrophoretic particles, but the disclosure is not limited thereto.

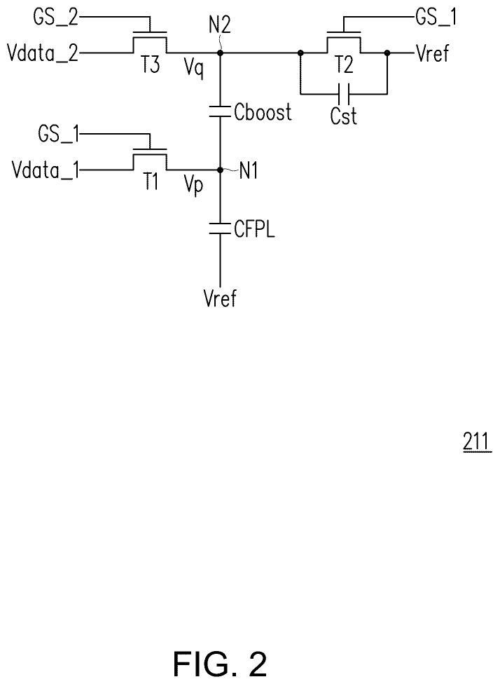

FIG. 2 is a circuit schematic diagram of a pixel unit according to an embodiment of the disclosure. Referring to FIG. 2, the circuit architecture of the pixel unit P(1,1) in FIG. 1 may be implemented as the circuit architecture of a pixel unit 211 shown in FIG. 2, and the circuit architecture of the pixel units P(2,1) to P(X,Y) is the same as the circuit architecture of the pixel unit P(1,1). In this embodiment, the pixel unit 211 includes a first transistor T1, a second transistor T2, a third transistor T3, an equivalent bootstrap capacitor Cboost, an equivalent pixel capacitor CFPL, and a storage capacitor Cst. In this embodiment, the first transistor T1, the second transistor T2, and the third transistor T3 may be N-type transistors (e.g., n-type metal-oxide-semiconductor field-effect Transistors, NMOSFETs), but the disclosure is not limited thereto. In an embodiment, the first transistor T1, the second transistor T2, and the third transistor T3 may also be P-type transistors. In this embodiment, first terminals and the second terminals of the first transistor T1, the second transistor T2, and the third transistor T3 may be divided into source terminals and drain terminals. Control terminals of the first transistor T1, the second transistor T2, and the third transistor T3 may be gate terminals.

In this embodiment, the first terminal of the first transistor T1 may receive a data voltage Vdata_1 from a data signal. The second terminal of the first transistor T1 is coupled to a first node N1. The control terminal of the first transistor T1 receives a scan signal GS_1 (also referred to as a gate signal). The first terminal of the second transistor T2 may receive a reference voltage Vref. The second terminal of the second transistor T2 is coupled to a second node N2. The control terminal of the second transistor T2 receives the scan signal GS_1. The first terminal of the third transistor T3 may receive a data voltage Vdata_2 from a data signal. The second terminal of the third transistor T3 is coupled to the second node N2. The control terminal of the third transistor T3 receives a scan signal GS_2. In this embodiment, the data voltage Vdata_1 may be equal to or may not be equal to the data voltage Vdata_2. The equivalent bootstrap capacitor Cboost is coupled between the first node N1 and the second node N2. The equivalent pixel capacitor CFPL is coupled between the first node N1 and the reference voltage Vref. The equivalent pixel capacitor CFPL may act as an equivalent capacitor between a positive electrode and a negative electrode of the electrophoretic unit. The storage capacitor Cst is coupled between the first terminal and the second terminal of the second transistor T2. The first node N1 may have a voltage Vp. The second node N2 may have a voltage Vq.

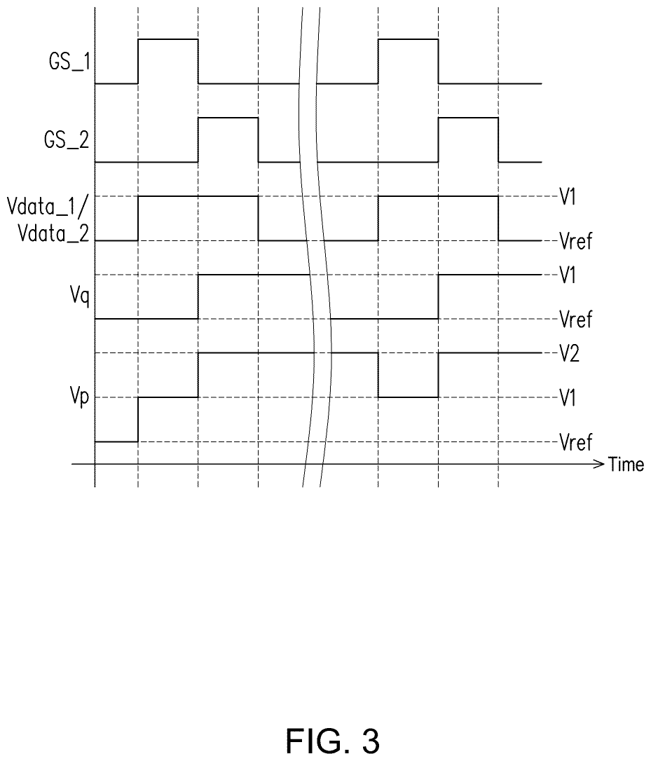

FIG. 3 is a waveform graph of a plurality of signals according to an embodiment of the disclosure. Referring to FIG. 2 and FIG. 3, the pixel unit 211 may perform a positive voltage driving operation according to the signals in FIG. 3. During a period from time t1 to time t2, the scan signal GS_1 is switched to a high voltage level, the scan signal GS_2 maintains at a low voltage level, and the data voltage Vdata_1 and the data voltage Vdata_2 are equal to a voltage V1. Accordingly, the first transistor T1 and the second transistor T2 may be operated in a turn-on state, and the third transistor T3 may be operated in a turn-off state. The first transistor T1 may provide the data voltage Vdata_1 having a positive voltage level to the first node N1, so that the voltage Vp of the first node N1 is equal to the data voltage Vdata_1. Further, the second transistor T2 may provide the reference voltage Vref to the second node N2, so that the voltage Vq of the second node N2 is equal to the reference voltage Vref.

During a period from time t2 to time t3, the scan signal GS_1 is switched to a low voltage level, the scan signal GS_2 is switched to a high voltage level, and the data voltage Vdata_1 and the data voltage Vdata_2 are equal to the voltage V1. Accordingly, the first transistor T1 and the second transistor T2 may be operated in a turn-off state, and the third transistor T3 may be operated in a turn-on state. The third transistor T3 may provide the data voltage Vdata_2 having a positive voltage level to the second node N2, so that the voltage Vq of the second node N2 rises to the voltage V1. Therefore, the voltage Vp of the first node N1 is further boosted to a voltage V2 based on the equivalent bootstrap capacitor Cboost. Further, in subsequent operations, description of the operations from time t4 to time t6 may refer to the foregoing description from time t1 to time t3. As such, the equivalent pixel capacitor CFPL may be effectively operated at the voltage V1 and the voltage V2 having positive voltage levels, so that a corresponding positive polarity voltage is provided to drive the corresponding electrophoretic particles in the pixel unit 211.

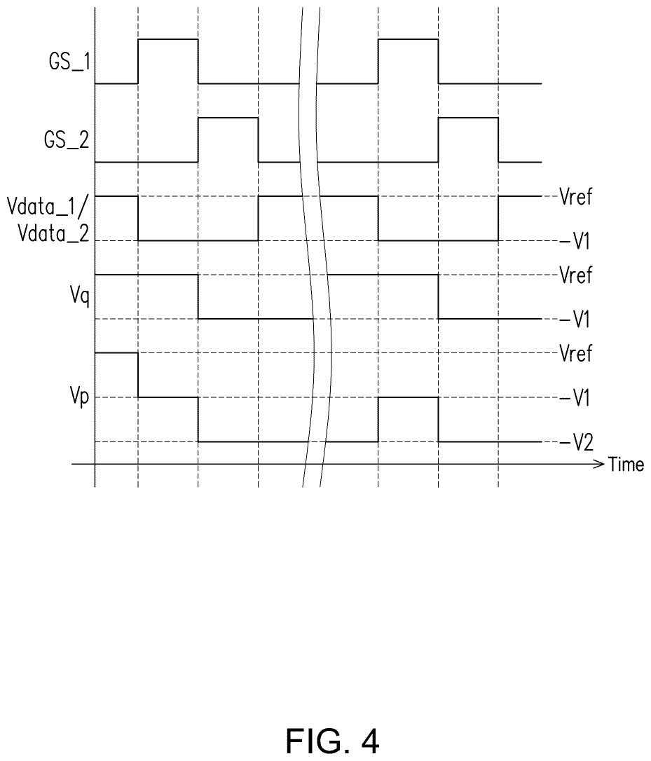

FIG. 4 is a waveform graph of a plurality of signals according to an embodiment of the disclosure. Referring to FIG. 2 and FIG. 4, the pixel unit 211 may perform a negative voltage driving operation according to the signals in FIG. 4. During the period from time t1 to time t2, the scan signal GS_1 is switched to a high voltage level, the scan signal GS_2 maintains at a low voltage level, and the data voltage Vdata_1 and the data voltage Vdata_2 are equal to a voltage −V1. Accordingly, the first transistor T1 and the second transistor T2 may be operated in a turn-on state, and the third transistor T3 may be operated in a turn-off state. The first transistor T1 may provide the data voltage Vdata_1 having a negative voltage level to the first node N1, so that the voltage Vp of the first node N1 is equal to the data voltage Vdata_1. Further, the second transistor T2 may provide the reference voltage Vref to the second node N2, so that the voltage Vq of the second node N2 is equal to the reference voltage Vref.

During the period from time t2 to time t3, the scan signal GS_1 is switched to a low voltage level, the scan signal GS_2 is switched to a high voltage level, and the data voltage Vdata_1 and the data voltage Vdata_2 are equal to the voltage −V1. Accordingly, the first transistor T1 and the second transistor T2 may be operated in a turn-off state, and the third transistor T3 may be operated in a turn-on state. The third transistor T3 may provide the data voltage Vdata_2 having a negative voltage level to the second node N2, so that the voltage Vq of the second node N2 decreases to the voltage −V1. Therefore, the voltage Vp of the first node N1 is further pulled down to a voltage −V2 based on the equivalent bootstrap capacitor Cboost. Further, in subsequent operations, the description of the operations from time t4 to time t6 may refer to the description of the aforementioned time t1 to time t3. As such, the equivalent pixel capacitor CFPL may be effectively operated at the voltage −V1 and the voltage −V2 having negative voltage levels, so that corresponding negative polarity voltages are provided to drive the corresponding electrophoretic particles in the pixel unit 211.

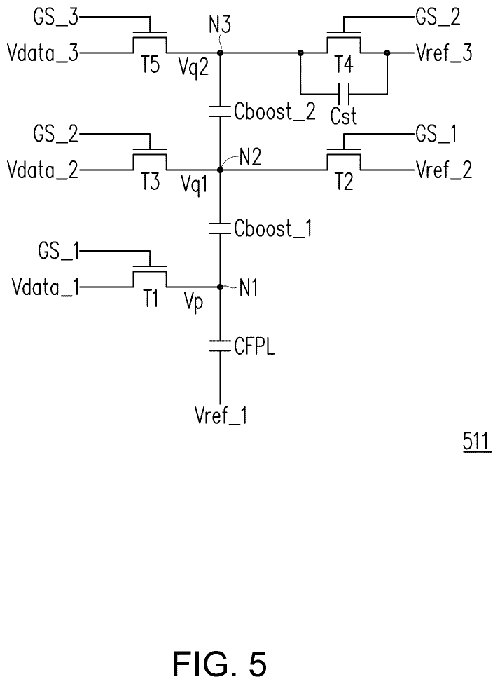

FIG. 5 is a circuit schematic diagram of a pixel unit according to an embodiment of the disclosure. Referring to FIG. 5, the circuit architecture of the pixel unit P(1,1) of FIG. 1 may be implemented as the circuit architecture of a pixel unit 511 shown in FIG. 5, and the circuit architectures of the pixel units P(2,1) to P(X,Y) are the same as the circuit architecture of the pixel unit P(1,1). In this embodiment, the pixel unit 511 includes a first transistor T1, a second transistor T2, a third transistor T3, a fourth transistor T4, a fifth transistor T5, an equivalent bootstrap capacitor Cboost, an equivalent pixel capacitor CFPL, and a storage capacitor Cst. In this embodiment, the first transistor T1, the second transistor T2, the third transistor T3, the fourth transistor T4, and the fifth transistor T5 may be N-type transistors, but the disclosure is not limited thereto. In an embodiment, the first transistor T1, the second transistor T2, the third transistor T3, the fourth transistor T4, and the fifth transistor T5 may also be P-type transistors. In this embodiment, first terminals and second terminals of the first transistor T1, the second transistor T2, the third transistor T3, the fourth transistor T4, and the fifth transistor T5 may be divided into source terminals and drain terminals. Control terminals of the first transistor T1, the second transistor T2, the third transistor T3, the fourth transistor T4, and the fifth transistor T5 may be gate terminals.

In this embodiment, the first terminal of the first transistor T1 may receive a data voltage Vdata_1 from a data signal. The second terminal of the first transistor T1 is coupled to the first node N1. The control terminal of the first transistor T1 receives a scan signal GS_1 (also referred to as a gate signal). The first terminal of the second transistor T2 may receive a reference voltage Vref_2. The second terminal of the second transistor T2 is coupled to the second node N2. The control terminal of the second transistor T2 receives the scan signal GS_1. The first terminal of the third transistor T3 may receive a data voltage Vdata_2 from a data signal. The second terminal of the third transistor T3 is coupled to the second node N2. The control terminal of the third transistor T3 receives a scan signal GS_2. The first terminal of the fourth transistor T4 may receive a reference voltage Vref_3. The second terminal of the fourth transistor T4 is coupled to the second node N3. The control terminal of the fourth transistor T4 receives the scan signal GS_2. The first terminal of the fifth transistor T5 may receive a data voltage Vdata_3 from a data signal. The second terminal of the fifth transistor T5 is coupled to the third node N3. The control terminal of the fifth transistor T5 receives a scan signal GS_3.

In this embodiment, the reference voltages Vref_1 to Vref_3 may be the same or different voltages. The data voltages Vdata_1 to Vdata_3 may be the same or different voltages. An equivalent bootstrap capacitor Cboost_1 is coupled between the first node N1 and the second node N2. An equivalent bootstrap capacitor Cboost_2 is coupled between the second node N2 and the third node N3. The equivalent pixel capacitor CFPL is coupled between the first node N1 and the reference voltage Vref_1. The equivalent pixel capacitor CFPL may act as an equivalent capacitor between the positive electrode and the negative electrode of the electrophoretic unit. The storage capacitor Cst is coupled between the first terminal and the second terminal of the fourth transistor T4. The first node N1 may have a voltage Vp. The second node N2 may have a voltage Vq1. The third node N3 may have a voltage Vq2.

In this embodiment, the pixel unit 511 may effectively raise or pull down the voltage of the equivalent pixel capacitor CFPL to a higher positive voltage or a lower negative voltage to a greater extent through the equivalent bootstrap capacitor Cboost_1 and the equivalent bootstrap capacitor Cboost_2. In this regard, the description of the specific operation of the pixel unit 511 may refer to the description of the embodiments in FIG. 3 and FIG. 4 above and thus is not repeated in detail herein.

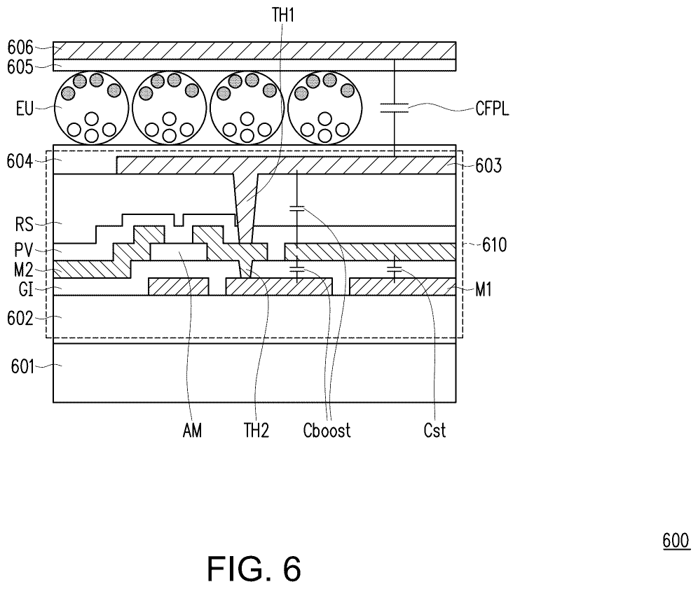

FIG. 6 is a (vertical) structural cross-sectional view of a pixel unit according to an embodiment of the disclosure. Referring to FIG. 6, the cross-sectional structure of each of the pixel units P(1,1) to P(X,Y) in FIG. 1 may be implemented as a pixel unit 600 shown in FIG. 6. In this embodiment, the pixel unit 600 includes a first material layer 602, a first metal layer M1, a first insulating layer GI, a second metal layer M2, a semiconductor thin film layer AM, a second insulating layer PV, a planarization layer RS, a pixel electrode layer 603, a second material layer 604, a third material layer 605, and an upper electrode layer 606 that are patterned and selectively formed above a substrate 601. An equivalent pixel capacitor CFPL may be formed between the pixel electrode layer 603 and the upper electrode layer 606, and a plurality of electrophoretic units EU are disposed. The pixel electrode layer 603 may include at least one of a metal layer and a transparent conductive electrode layer (e.g., an indium tin oxide (ITO) layer). The upper electrode layer 606 may be a transparent conductive electrode.

In this embodiment, in a pixel structure 610 of the pixel unit 600, the pixel electrode layer 603, the planarization layer RS, and the second insulating layer PV may form a through hole TH1, so that an electrical connection is formed between the pixel electrode layer 603 and a portion of the second metal layer M2. Further, the portion of the second metal layer M2 and the first insulating layer GI may form a through hole TH2, so that an electrical connection is formed between the portion of the second metal layer M2 and a portion of the first metal layer M1. In this way, an equivalent bootstrap capacitor Cboost may be formed among the pixel electrode layer 603, the planarization layer RS, the second insulating layer PV, the second metal layer M2, the first insulating layer GI, and the first metal layer M1. In addition, in the pixel structure 610 of the pixel unit 600, a storage capacitor Cst may also be formed among another portion of the second metal layer M2, the first insulating layer GI, and another portion of the first metal layer M1.

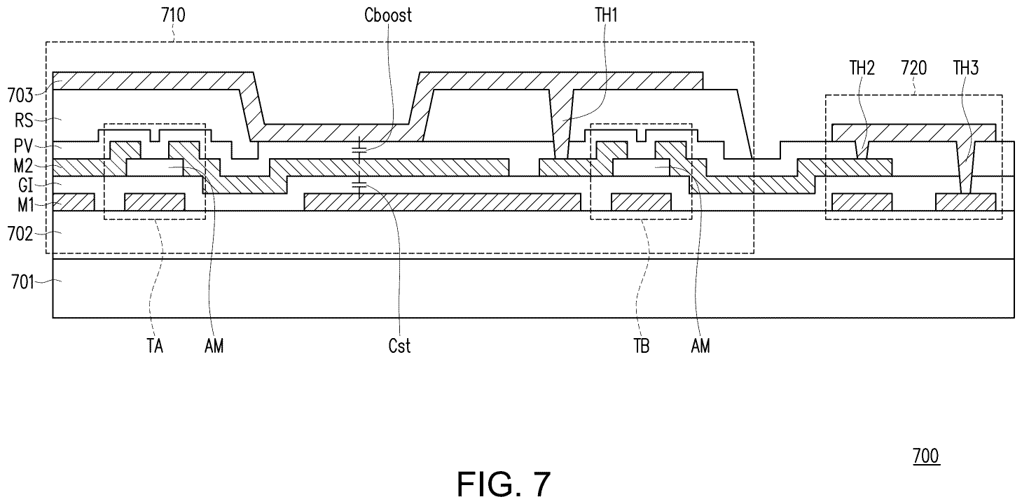

FIG. 7 is a structural cross-sectional view of a pixel unit according to an embodiment of the disclosure. Referring to FIG. 7, the cross-sectional structure of each of the pixel units P(1,1) to P(X,Y) in FIG. 1 may be implemented as a pixel unit 700 shown in FIG. 7. In this embodiment, the pixel unit 700 includes a first material layer 702, a first metal layer M1, a first insulating layer GI, a second metal layer M2, a semiconductor thin film layer AM, a second insulating layer PV, a planarization layer RS, and a pixel electrode layer 703 that are patterned and selectively formed in sequence above a substrate 701. The material layer, the plurality of electrophoretic units, and the upper electrode layer as shown in FIG. 6 may also be disposed above the pixel electrode layer 703, and an equivalent pixel capacitor may be formed. In an embodiment, at least one of the second insulating layer PV and the planarization layer RS may be formed on the second metal layer M2, and is not limited to that shown in FIG. 7. Further, in an embodiment, the pixel electrode layer 703 may include a third metal layer and a transparent conductive electrode layer formed in sequence, or may include only a transparent conductive electrode layer.

In this embodiment, the pixel unit 700 includes a pixel structure 710. The pixel structure 710 includes a through hole TH1, where the through hole TH1 is formed among the second metal layer M2, the second insulating layer PV, the planarization layer RS, and the pixel electrode layer 703. In this way, in a removal region of the planarization layer RS, an equivalent bootstrap capacitor Cboost may be formed among the second metal layer M2, the second insulating layer PV, and the pixel electrode layer 703. Further, the pixel structure 710 also includes a storage capacitor Cst formed via the first metal layer M1, the first insulating layer GI, and the second metal layer M2. In addition, the pixel structure 710 also includes transistor structures TA and TB (i.e., the above-mentioned first to third transistors). Each of the transistor structures TA and TB is formed by the corresponding first metal layer M1, the corresponding first insulating layer GI, the corresponding semiconductor thin film layer AM, and the corresponding second metal layer M2.

In this embodiment, the pixel unit 700 also includes a connection pad structure 720. The connection pad structure 720 includes a through hole TH2 and a through hole TH3. The through hole TH2 is formed among the second metal layer M2, the second insulating layer PV, and the pixel electrode layer 703. The through hole TH3 is formed among the first metal layer M1, the first insulating layer GI, the second insulating layer PV, and the pixel electrode layer 703. In this way, an electrical connection may be formed between the corresponding first metal layer M1 and the corresponding second metal layer M2 through the pixel electrode layer 703.

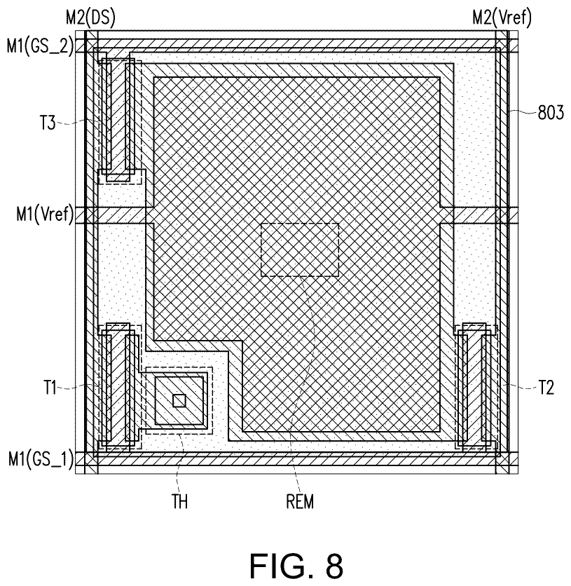

FIG. 8 is a layout diagram of a pixel unit according to an embodiment of the disclosure. Referring to FIG. 8, the semiconductor process layout of FIG. 8 may be applicable to the top-view layout result of the pixel unit 700 of the embodiment of FIG. 7, but this embodiment is not limited thereto. In FIG. 8, the first metal layer M1, the second metal layer M2, and a pixel electrode layer 803 may be patterned and sequentially formed to be stacked on the substrate (also including other material layers, insulating layers, etc.). As shown in FIG. 8, a portion of the first metal layer M1 and a portion of the second metal layer M2 may form the first to third transistors T1 to T3. The pixel electrode layer 803 covers the uppermost layer. A portion of the second metal layer M2 and the pixel electrode layer 803 may form an electrical connection through the through hole TH.

In a planarization layer removal region REM (the removal region of the planarization layer RS as shown in FIG. 7), a storage capacitor Cst may be formed between the first metal layer M1 and the second metal layer M2, and an equivalent bootstrap capacitor Cboost may be formed between the second metal layer M2 and the pixel electrode layer 803. In addition, the upper first metal layer M1 may form a trace and may act as a scan signal line for transmitting the scan signal GS_2. The upper first metal layer M1 may form a trace and may act as another scan signal line for transmitting the scan signal GS_1. The left second metal layer M2 may form a trace and may act as a data signal line for transmitting the data signal DS. The first metal layer M1 on both sides of the middle may form traces and may act as reference voltage lines for transmitting the reference voltage Vref. The right second metal layer M2 may form a trace and may act as another reference voltage line for transmitting the reference voltage Vref.

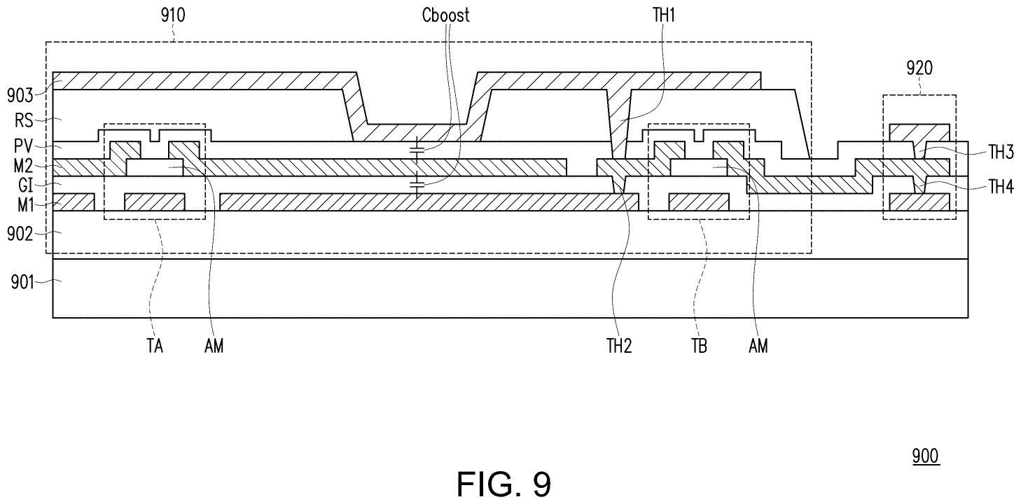

FIG. 9 is a structural cross-sectional view of a pixel unit according to an embodiment of the disclosure. Referring to FIG. 9, the cross-sectional structure of each of the pixel units P(1,1) to P(X,Y) of FIG. 1 may be implemented as a pixel unit 900 shown in FIG. 9. In this embodiment, the pixel unit 900 includes a first material layer 902, a first metal layer M1, a first insulating layer GI, a second metal layer M2, a semiconductor thin film layer AM, a second insulating layer PV, a planarization layer RS, and a pixel electrode layer 903 that are patterned and selectively formed in sequence above a substrate 901. Above the pixel electrode layer 903, the material layer, the electrophoretic units, and the upper electrode layer as shown in FIG. 6 may also be disposed, and an equivalent pixel capacitor may be formed. In an embodiment, at least one of the second insulating layer PV and the planarization layer RS may be selectively formed on the second metal layer M2, and is not limited to that shown in FIG. 9. Further, in an embodiment, the pixel electrode layer 903 may include a third metal layer and a transparent conductive electrode layer sequentially formed, or may include only a transparent conductive electrode layer.

In this embodiment, the pixel unit 900 includes a pixel structure 910. The pixel structure 910 includes a through hole TH1 and a through hole TH2. The through hole TH1 is formed among the second metal layer M2, the second insulating layer PV, the planarization layer RS, and the pixel electrode layer 903. The through hole TH2 is formed among the first metal layer M1, the first insulating layer GI, and the second metal layer M2. In this way, in the removal region of the planarization layer RS, an equivalent bootstrap capacitor Cboost may be formed among the first metal layer M1, the first insulating layer GI, the second metal layer M2, the second insulating layer PV, and the pixel electrode layer 903. In addition, the pixel structure 910 further includes transistor structures TA and TB (i.e., the above-mentioned first to third transistors). Each of the transistor structures TA and TB is formed by the corresponding first metal layer M1, the corresponding first insulating layer GI, the corresponding semiconductor thin film layer AM, and the corresponding second metal layer M2.

In this embodiment, the pixel unit 900 further includes a connection pad structure 920. The connection pad structure 920 includes a through hole TH3 and a through hole TH4. The through hole TH3 is formed among the second metal layer M2, the second insulating layer PV, and the pixel electrode layer 903. The through hole TH4 is formed among the first metal layer M1, the first insulating layer GI, and the second metal layer M2. In this way, an electrical connection is formed among the corresponding first metal layer M1, the corresponding second metal layer M2, and the pixel electrode layer 903.

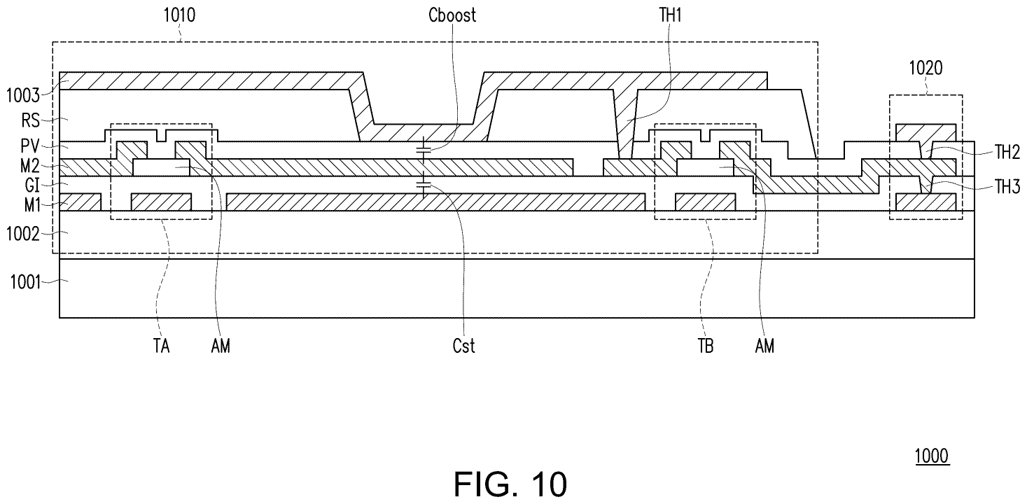

FIG. 10 is a structural cross-sectional view of a pixel unit according to an embodiment of the disclosure. The cross-sectional structure of each of the pixel units P(1,1) to P(X,Y) in FIG. 1 may be implemented as a pixel unit 1000 shown in FIG. 10. In this embodiment, the pixel unit 1000 includes a first material layer 1002, a first metal layer M1, a first insulating layer GI, a second metal layer M2, a semiconductor thin film layer AM, a second insulating layer PV, a planarization layer RS, and a pixel electrode layer 903 that are patterned and selectively formed in sequence above a substrate 1001. Above a pixel electrode layer 1003, the material layer, the plurality of electrophoretic units, and the upper electrode layer as shown in FIG. 6 may be further disposed, and an equivalent pixel capacitor may be formed. In an embodiment, at least one of the second insulating layer PV and the planarization layer RS may be selectively formed on the second metal layer M2, and is not limited to that shown in FIG. 9. Further, in an embodiment, the pixel electrode layer 1003 may include a third metal layer and a transparent conductive electrode layer formed in sequence, or may include only a transparent conductive electrode layer.

In this embodiment, the pixel unit 1000 includes a pixel structure 1010. The pixel structure 1010 includes a through hole TH1. The through hole TH1 is formed among the second metal layer M2, the second insulating layer PV, the planarization layer RS, and the pixel electrode layer 1003. In this way, in the removal region of the planarization layer RS, the second metal layer M2, the second insulating layer PV, and the pixel electrode layer 1003 may form an equivalent bootstrap capacitor Cboost. Further, a storage capacitor Cst may be formed among the first metal layer M1, the first insulating layer GI, and the second metal layer M2. In addition, the pixel structure 1010 further includes transistor structures TA and TB (i.e., the above-mentioned first to third transistors). Each of the transistor structures TA and TB is formed by the corresponding first metal layer M1, the corresponding first insulating layer GI, the corresponding semiconductor thin film layer AM, and the corresponding second metal layer M2.

In this embodiment, the pixel unit 1000 further includes a connection pad structure 1020. The connection pad structure 1020 includes a through hole TH2 and a through hole TH3. The through hole TH2 is formed among the second metal layer M2, the second insulating layer PV, and the pixel electrode layer 1003. The through hole TH3 is formed among the first metal layer M1, the first insulating layer GI, and the second metal layer M2. In this way, an electrical connection is formed among the corresponding first metal layer M1, the corresponding second metal layer M2, and the pixel electrode layer 1003.

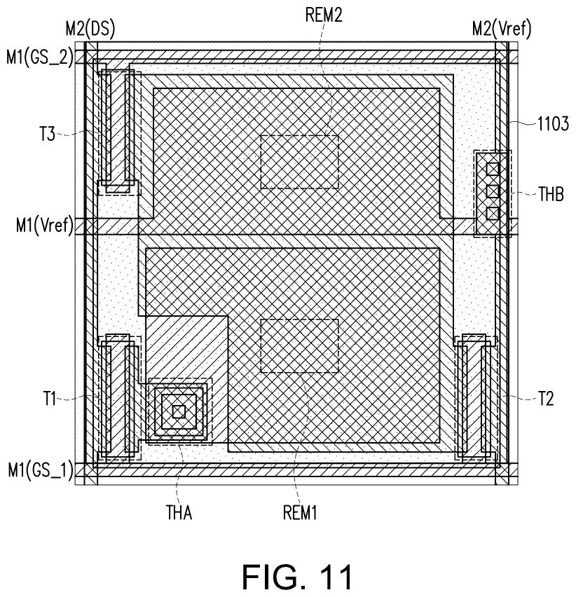

FIG. 11 is a layout diagram of a pixel unit according to an embodiment of the disclosure. Referring to FIG. 11, the semiconductor process layout of FIG. 11 may be applicable to the top-view layout result of the pixel unit 900 of the embodiment of FIG. 9, but this embodiment is not limited thereto. In FIG. 11, the first metal layer M1, the second metal layer M2, and a pixel electrode layer 1103 may be patterned and sequentially formed to be stacked on the substrate (also including other material layers, insulating layers, etc.). As shown in FIG. 11, a portion of the first metal layer M1 and a portion of the second metal layer M2 may form the first to third transistors T1 to T3. The pixel electrode layer 1103 covers the uppermost layer. A portion of the first metal layer M1, a portion of the second metal layer M2, and the pixel electrode layer 1103 may form an electrical connection through a through hole THA. In this way, in a planarization layer removal region REM1 (e.g., the removal region of the planarization layer RS as shown in FIG. 9), an equivalent bootstrap capacitor Cboost may be formed among the first metal layer M1, the second metal layer M2, and the pixel electrode layer 1103. Further, another portion of the first metal layer M1 and another portion of the second metal layer M2 may form an electrical connection through a through hole THB. In this way, in a planarization layer removal region REM2 (e.g., the removal region of another planarization layer RS as shown in FIG. 9), a storage capacitor Cst may be formed between the first metal layer M1 and the second metal layer M2.

In addition, the first metal layer M1 on the upper side may form a trace and may act as a scan signal line for transmitting the scan signal GS_2. The first metal layer M1 on the upper side may form a trace and may act as another scan signal line for transmitting the scan signal GS_1. The second metal layer M2 on the left side may form a trace and may act as a data signal line for transmitting the data signal DS. The first metal layer M1 on both sides of the middle may form traces and may act as reference voltage lines for transmitting the reference voltage Vref. The second metal layer M2 on the right side may form a trace and may act as another reference voltage line for transmitting the reference voltage Vref.

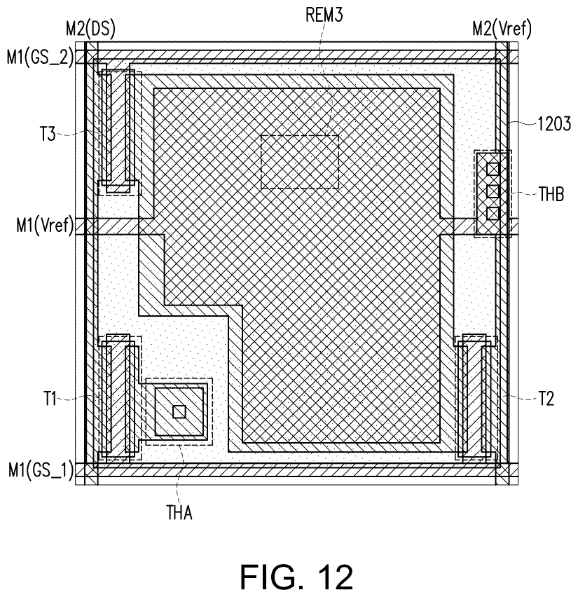

FIG. 12 is a layout diagram of a pixel unit according to an embodiment of the disclosure. Referring to FIG. 12, the semiconductor process layout of FIG. 12 may be applicable to the top-view layout result of the pixel unit 1000 of the embodiment of FIG. 10, but this embodiment is not limited thereto. In FIG. 12, the first metal layer M1, the second metal layer M2, and a pixel electrode layer 1203 may be patterned and sequentially formed to be stacked on the substrate (also including other material layers, insulating layers, etc.). As shown in FIG. 12, a portion of the first metal layer M1 and a portion of the second metal layer M2 may form the first to third transistors T1 to T3. The pixel electrode layer 1203 covers the uppermost layer. A portion of the second metal layer M2 and the pixel electrode layer 1203 may be electrically connected through the through hole THA. In this way, in the planarization layer removal region REM1 (e.g., the removal region of the planarization layer RS as shown in FIG. 10), an equivalent bootstrap capacitor Cboost may be formed between the second metal layer M2 and the pixel electrode layer 1203. In addition, another portion of the first metal layer M1 and another portion of the second metal layer M2 may be electrically connected through the through hole THB. In this way, the storage capacitor Cst may be formed between the first metal layer M1 and the second metal layer M2.

In addition, the first metal layer M1 on the upper side may form a trace and may act as a scan signal line for transmitting the scan signal GS_2. The first metal layer M1 on the upper side may form a trace and may act as another scan signal line for transmitting the scan signal GS_1. The second metal layer M2 on the left side may form a trace and may act as a data signal line for transmitting the data signal DS. The first metal layer M1 on both sides of the middle may form traces and may act as reference voltage lines for transmitting the reference voltage Vref. The second metal layer M2 on the right side may form a trace and may act as another reference voltage line for transmitting the reference voltage Vref.

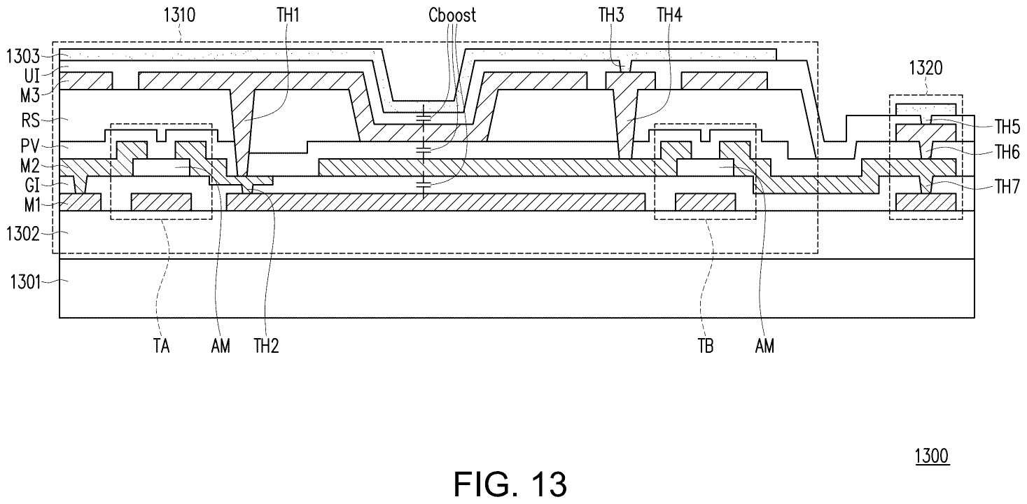

FIG. 13 is a structural cross-sectional diagram of a pixel unit according to an embodiment of the disclosure. Referring to FIG. 13, the cross-sectional structure of each of the pixel units P(1,1) to P(X,Y) of FIG. 1 may be implemented as a pixel unit 1300 shown in FIG. 13. In this embodiment, the pixel unit 1300 includes a first material layer 1302, a first metal layer M1, a first insulating layer GI, a second metal layer M2, a semiconductor thin film layer AM, a second insulating layer PV, a planarization layer RS, a third electrode layer M3, a third insulating layer UI, and a pixel electrode layer 1303 that are patterned and selectively formed in sequence above a substrate 1301. Above the pixel electrode layer 1303, the material layer, the electrophoretic units, and the upper electrode layer as shown in FIG. 6 may be further disposed, and an equivalent pixel capacitor may be formed. In an embodiment, at least one of the second insulating layer PV and the planarization layer RS may be selectively formed on the second metal layer M2, and is not limited to that shown in FIG. 13. In addition, in an embodiment, the pixel electrode layer 1303 may include a fourth metal layer and a transparent conductive electrode layer sequentially formed, or may include only a transparent conductive electrode layer.

In this embodiment, the pixel unit 1300 includes a pixel structure 1310. The pixel structure 1310 includes through holes TH1 to TH4. The through hole TH1 is formed among the second metal layer M2, the second insulating layer PV, the planarization layer RS, and the third electrode layer M3. The through hole TH2 is formed among the first metal layer M1, the first insulating layer GI, and the second metal layer M2. In this way, an equivalent bootstrap capacitor Cboost may be formed among the third metal layer M3, the third insulating layer UI, and the pixel electrode layer 1303. Further, the through hole TH3 is formed among another portion of the third metal layer M3, the third insulating layer UI, and the pixel electrode layer 1303. The through hole TH4 is formed among another portion of the first metal layer M1, the first insulating layer GI, and another portion of the second metal layer M2. In this way, the equivalent bootstrap capacitor Cboost may be formed among the first metal layer M1, the first insulating layer GI, the second metal layer M2, the second insulating layer PV, the planarization layer RS, and the third metal layer M3. In addition, the pixel structure 1310 further includes transistor structures TA and TB (i.e., the above-mentioned first to third transistors). Each of the transistor structures TA and TB is formed by the corresponding first metal layer M1, the corresponding first insulating layer GI, the corresponding semiconductor thin film layer AM, and the corresponding second metal layer M2.

In this embodiment, the pixel unit 1300 further includes a connection pad structure 1320. The connection pad structure 1320 includes through holes TH5 to TH7. The through hole TH5 is formed among the third metal layer M3, the third insulating layer UI, and the pixel electrode layer 1303. The through hole TH6 is formed among the second metal layer M2, the second insulating layer PV, and the third metal layer M3. The through hole TH7 is formed among the first metal layer M1, the first insulating layer GI, and the second metal layer M2. In this way, an electrical connection is formed among the corresponding first metal layer M1, the corresponding second metal layer M2, the corresponding third metal layer M3, and the pixel electrode layer 1303.

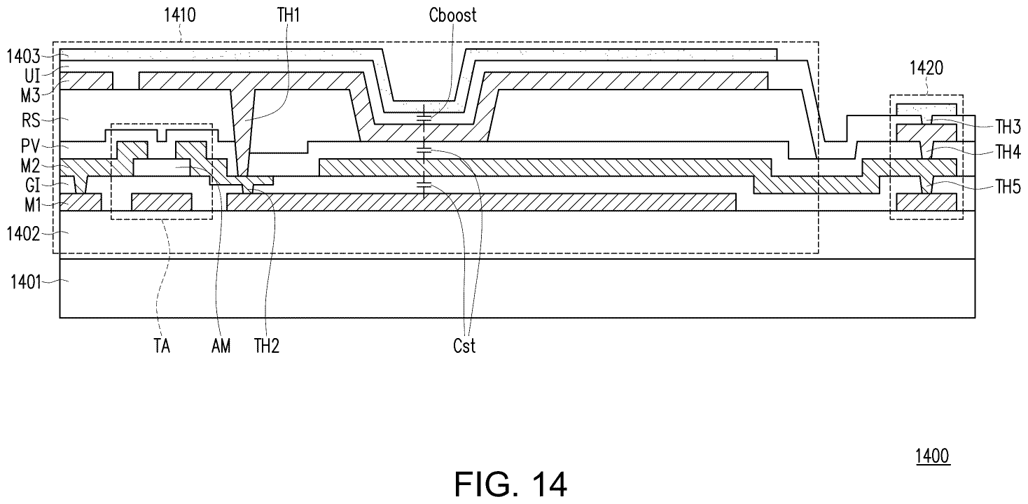

FIG. 14 is a structural cross-sectional view of a pixel unit according to an embodiment of the disclosure. Referring to FIG. 14, the cross-sectional structure of each of the pixel units P(1,1) to P(X,Y) of FIG. 1 may be implemented as a pixel unit 1400 shown in FIG. 14. In this embodiment, the pixel unit 1400 includes a first material layer 1402, a first metal layer M1, a first insulating layer GI, a second metal layer M2, a semiconductor thin film layer AM, a second insulating layer PV, a planarization layer RS, a third electrode layer M3, a third insulating layer UI, and a pixel electrode layer 1403 that are patterned and selectively formed in sequence above a substrate 1401. Above the pixel electrode layer 1403, the material layer, the plurality of electrophoretic units, and the upper electrode layer as shown in FIG. 6 may be further disposed, and an equivalent pixel capacitor may be formed. In an embodiment, at least one of the second insulating layer PV and the planarization layer RS may be selectively formed on the second metal layer M2, and is not limited to that shown in FIG. 14. Further, in an embodiment, the pixel electrode layer 1303 may include a fourth metal layer and a transparent conductive electrode layer formed sequentially, or may include only a transparent conductive electrode layer.

In this embodiment, the pixel unit 1400 includes a pixel structure 1410. The pixel structure 1410 includes a through hole TH1 and a through hole TH2. The through hole TH1 is formed among the second metal layer M2, the second insulating layer PV, the planarization layer RS, and the third electrode layer M3. The through hole TH2 is formed among the first metal layer M1, the first insulating layer GI, and the second metal layer M2. In this way, an equivalent bootstrap capacitor Cboost may be formed among the third metal layer M3, the third insulating layer UI, and the pixel electrode layer 1403. In addition, the pixel structure 1410 further includes a transistor structure TA (i.e., the above-mentioned first to third transistors). The transistor structure TA is formed by the corresponding first metal layer M1, the corresponding first insulating layer GI, the corresponding semiconductor thin film layer AM, and the corresponding second metal layer M2.

In this embodiment, the pixel unit 1400 further includes a connection pad structure 1420. The connection pad structure 1420 includes through holes TH3 to TH5. The through hole TH3 is formed among the third metal layer M3, the third insulating layer UI, and the pixel electrode layer 1303. The through hole TH4 is formed among the second metal layer M2, the second insulating layer PV, and the third metal layer M3. The through hole TH5 is formed among the first metal layer M1, the first insulating layer GI, and the second metal layer M2. In this way, an electrical connection is formed among the corresponding first metal layer M1, the corresponding second metal layer M2, the corresponding third metal layer M3, and the pixel electrode layer 1403. Further, a storage capacitor Cst may be formed among the first metal layer M1, the first insulating layer GI, the second metal layer M2, the second insulating layer PV, the planarization layer RS, and the third metal layer M3.

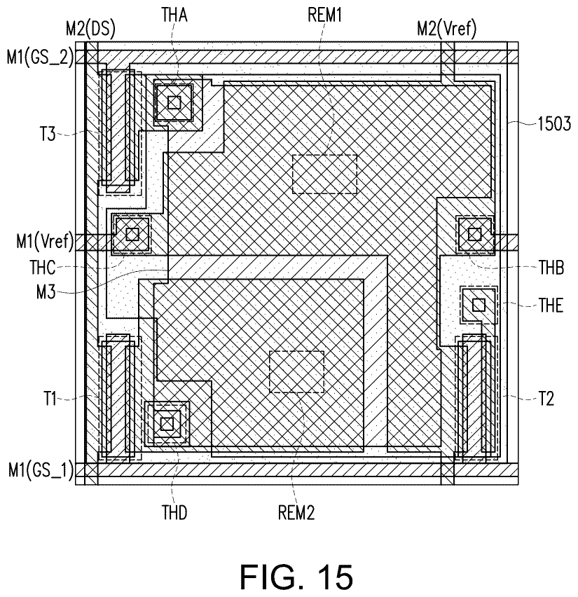

FIG. 15 is a layout diagram of a pixel unit according to an embodiment of the disclosure. Referring to FIG. 15, the semiconductor process layout of FIG. 15 may be applicable to the top-view layout results of the pixel unit 1300 and the pixel unit 1400 in the embodiments of FIG. 13 and FIG. 14, but this embodiment is not limited thereto. In FIG. 15, the first metal layer M1, the second metal layer M2, the third metal layer M3, and a pixel electrode layer 1503 may be patterned and sequentially formed to be stacked on the substrate (also including other material layers, insulating layers, etc.). As shown in FIG. 15, a portion of the first metal layer M1 and a portion of the second metal layer M2 may form the first to third transistors T1 to T3. The pixel electrode layer 1503 covers the uppermost layer.

In the upper portion of the layout, a portion of the first metal layer M1, a portion of the second metal layer M2, and a portion of the third metal layer M3 may form an electrical connection through the through hole THA. Alternatively, a portion of the second metal layer M2 and a portion of the third metal layer M3 may form an electrical connection through the through hole THA. Alternatively, a portion of the first metal layer M1 and a portion of the second metal layer M2 may form an electrical connection through the through hole THA. Further, another portion of the first metal layer M1 and another portion of the second metal layer M2 may form an electrical connection through the through hole THB. Yet another portion of the first metal layer M1 and yet another portion of the second metal layer M2 may form an electrical connection through a through hole THC. In this way, in the planarization layer removal region REM1, a storage capacitor Cst may be formed among the first metal layer M1, the second metal layer M2, and the third metal layer M3.

In the lower portion of the layout, a portion of the second metal layer M2, a portion of the third metal layer M3, and the pixel electrode layer 1503 may form an electrical connection through a through hole THD. Further, a portion of the first metal layer M1, a portion of the second metal layer M2, and a portion of the third metal layer M3 may form an electrical connection through a through hole THE. Alternatively, a portion of the second metal layer M2 and a portion of the third metal layer M3 may form an electrical connection through the through hole THE. Alternatively, a portion of the first metal layer M1 and a portion of the second metal layer M2 may form an electrical connection through the through hole THE. In this way, in the planarization layer removal region REM2, an equivalent bootstrap capacitor Cboost may be formed among the first metal layer M1, the second metal layer M2, the third metal layer M3, and the pixel electrode layer 1503.

In addition, the upper first metal layer M1 may form a trace and may act as a scan signal line for transmitting the scan signal GS_2. The upper first metal layer M1 may form a trace and may act as another scan signal line for transmitting the scan signal GS_1. The left second metal layer M2 may form a trace and may act as a data signal line for transmitting the data signal DS. The first metal layer M1 on both sides of the middle may form traces and may act as reference voltage lines for transmitting the reference voltage Vref. The right second metal layer M2 may form a trace and may act as another reference voltage line for transmitting the reference voltage Vref.

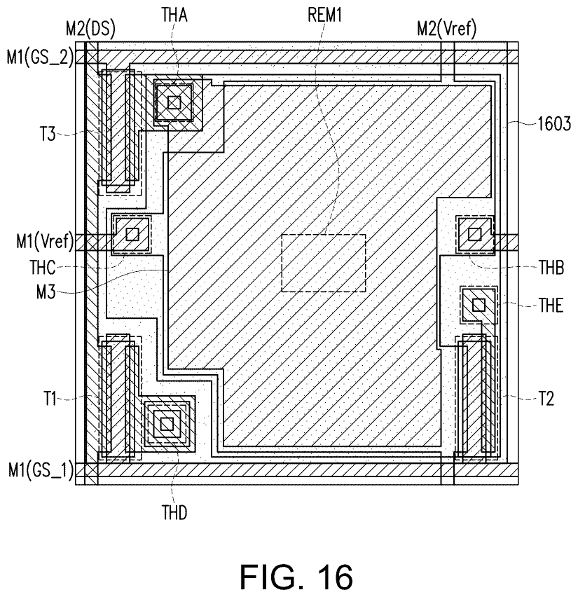

FIG. 16 is a layout diagram of a pixel unit according to an embodiment of the disclosure. Referring to FIG. 16, the semiconductor process layout of FIG. 16 may be applicable to the top-view layout results of the pixel unit 1300 and the pixel unit 1400 in the embodiments of FIG. 13 and FIG. 14, but this embodiment is not limited thereto. In FIG. 16, the first metal layer M1, the second metal layer M2, the third metal layer M3, and a pixel electrode layer 1603 may be patterned and sequentially formed to be stacked on the substrate (also including other material layers, insulating layers, etc.). As shown in FIG. 16, a portion of the first metal layer M1 and a portion of the second metal layer M2 may form the first to third transistors T1 to T3. The pixel electrode layer 1603 covers the uppermost layer.

A portion of the first metal layer M1, a portion of the second metal layer M2, and a portion of the third metal layer M3 may be electrically connected through the through hole THA. Alternatively, a portion of the second metal layer M2 and a portion of the third metal layer M3 may be electrically connected through the through hole THA. Alternatively, a portion of the first metal layer M1 and a portion of the second metal layer M2 may be electrically connected through the through hole THA. Another portion of the first metal layer M1 and another portion of the second metal layer M2 may be electrically connected through the through hole THB. Different portions of the first metal layer M1 and different portions of the second metal layer M2 may be electrically connected through the through hole THC. Different portions of the second metal layer M2, different portions of the third metal layer M3, and the pixel electrode layer 1603 may be electrically connected through the through hole THD. Further, different portions of the first metal layer M1, different portions of the second metal layer M2, and different portions of the third metal layer M3 may be electrically connected through the through hole THE. Alternatively, different portions of the second metal layer M2 and different portions of the third metal layer M3 may be electrically connected through the through hole THE. Alternatively, different portions of the first metal layer M1 and different portions of the second metal layer M2 may be electrically connected through the through hole THE. As such, in the planarization layer removal region REM1, the storage capacitor Cst may be formed between the first metal layer M1, the second metal layer M2, and the third metal layer M3. Further, an equivalent bootstrap capacitor Cboost may be formed between the third metal layer M3 and the pixel electrode layer 1603.

In addition, the first metal layer M1 on the upper side may form a trace and may act as a scan signal line for transmitting the scan signal GS_2. The first metal layer M1 on the upper side may form a trace and may act as another scan signal line for transmitting the scan signal GS_1. The second metal layer M2 on the left side may form a trace and may act as a data signal line for transmitting the data signal DS. The first metal layer M1 on both sides of the middle may form traces and may act as reference voltage lines for transmitting the reference voltage Vref. The second metal layer M2 on the right side may form a trace and may act as another reference voltage line for transmitting the reference voltage Vref.

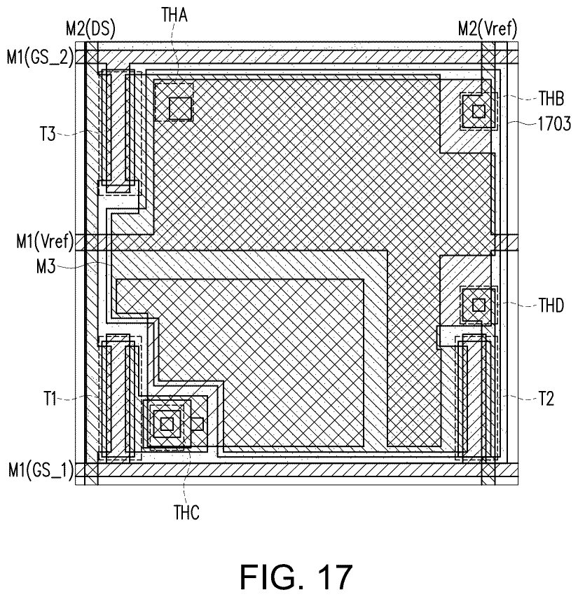

FIG. 17 is a layout diagram of a pixel unit according to an embodiment of the disclosure. Referring to FIG. 17, the semiconductor process layout of FIG. 17 may be applicable to the top-view layout results of the pixel unit 1300 and the pixel unit 1400 of the embodiments of FIG. 13 and FIG. 14, but the embodiment is not limited thereto. In FIG. 17, the first metal layer M1, the second metal layer M2, the third metal layer M3, and a pixel electrode layer 1703 may be patterned and sequentially formed to be stacked on the substrate (also including other material layers, insulating layers, etc.). As shown in FIG. 17, a portion of the first metal layer M1 and a portion of the second metal layer M2 may form the first to third transistors T1 to T3. The pixel electrode layer 1703 covers the uppermost layer.

In the upper half of the layout, a portion of the second metal layer M2 and a portion of the third metal layer M3 may be electrically connected through the through hole THA. In addition, another portion of the first metal layer M1 and another portion of the second metal layer M2 may be electrically connected through the through hole THB. As such, in the upper half of the layout, a storage capacitor Cst may be formed between the first metal layer M1 and the second metal layer M2.

In the lower half of the layout, a portion of the first metal layer M1, the second metal layer M2, a portion of the third metal layer M3, and the pixel electrode layer 1703 may be electrically connected through the through hole THC. In addition, another portion of the first metal layer M1 and another portion of the second metal layer M2 may be electrically connected through the through hole THD. As such, in the lower half of the layout, an equivalent bootstrap capacitor Cboost may be formed among the first metal layer M1, the second metal layer M2, the third metal layer M3, and the pixel electrode layer 1703.

In addition, the upper first metal layer M1 may form a trace and may act as a scan signal line for transmitting the scan signal GS_2. The upper first metal layer M1 may form a trace and may act as another scan signal line for transmitting the scan signal GS_1. The left second metal layer M2 may form a trace and may act as a data signal line for transmitting the data signal DS. The first metal layer M1 on both sides of the middle may form traces and may act as reference voltage lines for transmitting the reference voltage Vref. The right second metal layer M2 may form a trace and may act as another reference voltage line for transmitting the reference voltage Vref.

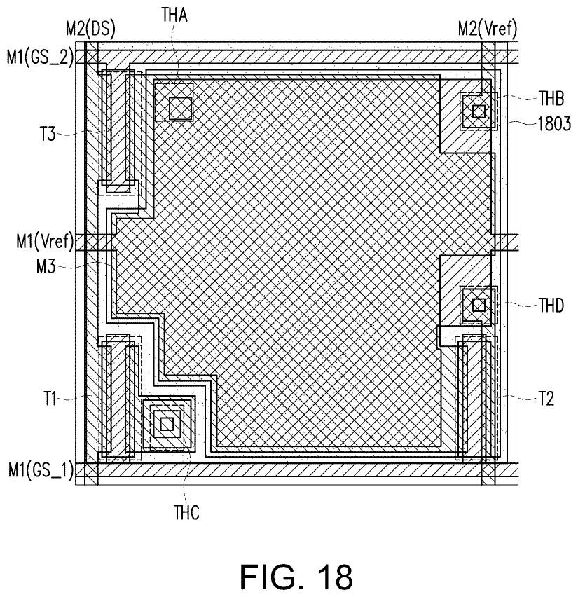

FIG. 18 is a layout diagram of a pixel unit according to an embodiment of the disclosure. Referring to FIG. 18, the semiconductor process layout of FIG. 18 may be applicable to the top-view layout results of the pixel unit 1300 and the pixel unit 1400 of the embodiments of FIG. 13 and FIG. 14, but this embodiment is not limited thereto. In FIG. 18, the first metal layer M1, the second metal layer M2, the third metal layer M3, and a pixel electrode layer 1803 may be patterned and sequentially formed to be stacked on the substrate (also including other material layers, insulating layers, etc.). As shown in FIG. 18, a portion of the first metal layer M1 and a portion of the second metal layer M2 may form the first to third transistors T1 to T3. The pixel electrode layer 1803 covers the uppermost layer.

In the upper half of the layout, a portion of the second metal layer M2 and a portion of the third metal layer M3 may be electrically connected through the through hole THA. In addition, another portion of the first metal layer M1 and another portion of the second metal layer M2 may be electrically connected through the through hole THB. As such, in the upper half of the layout, a storage capacitor Cst may be formed between the first metal layer M1 and the second metal layer M2.

In the lower half of the layout, the second metal layer M2, a portion of the third metal layer M3, and the pixel electrode layer 1803 may be electrically connected through the through hole THC. In addition, another portion of the first metal layer M1 and another portion of the second metal layer M2 may be electrically connected through the through hole THD. As such, in the lower half of the layout, an equivalent bootstrap capacitor Cboost may be formed between the third metal layer M3 and the pixel electrode layer 1803.

In addition, the upper first metal layer M1 may form a trace and may act as a scan signal line for transmitting the scan signal GS_2. The upper first metal layer M1 may form a trace and may act as another scan signal line for transmitting the scan signal GS_1. The left second metal layer M2 may form a trace and may act as a data signal line for transmitting the data signal DS. The first metal layer M1 on both sides of the middle may form traces and may act as reference voltage lines for transmitting the reference voltage Vref. The right second metal layer M2 may form a trace and may act as another reference voltage line for transmitting the reference voltage Vref.

It should be noted that the element structure and layout structure of the pixel unit described in the above embodiments of FIG. 7 to FIG. 18 are used to illustrate how to implement the storage capacitor and the equivalent bootstrap capacitor as described in the embodiments of FIG. 2 and FIG. 5.

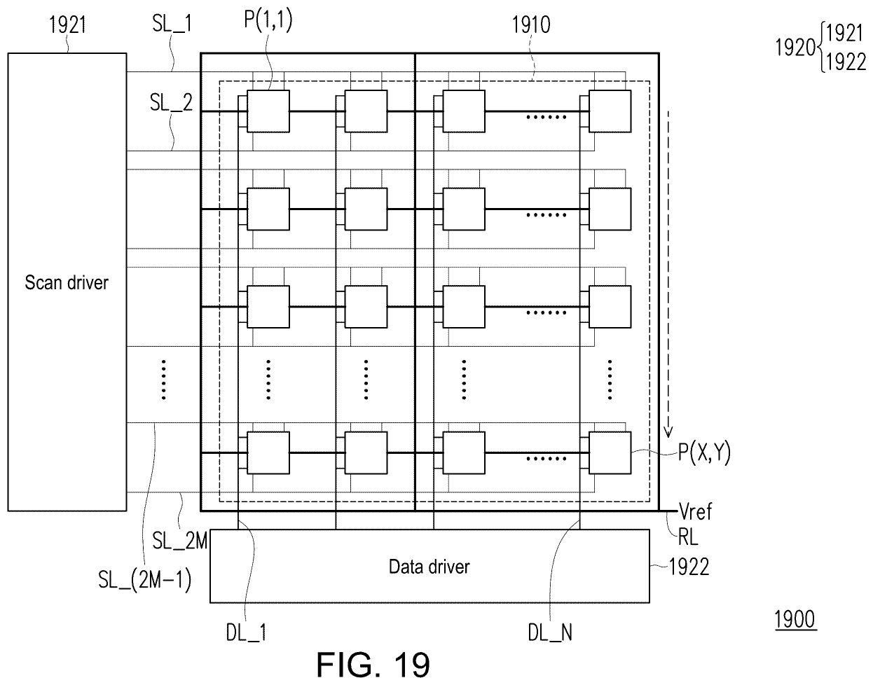

FIG. 19 is a circuit schematic diagram of a display device according to an embodiment of the disclosure. Referring to FIG. 19, the display device 100 of FIG. 1 may implement the circuit configuration of a display device 1900 as shown in FIG. 19. In this embodiment, the display device 1900 includes a pixel array 1910 and a driving circuit 1920. The pixel array 1910 includes a plurality of pixel units P(1,1) to P(X,Y). The driving circuit 1920 includes a scan driver 1921 and a data driver 1922. The pixel units P(1,1) to P(X,Y) of the pixel array 1910 are coupled to the reference voltage line RL to receive the reference voltage Vref.

In this embodiment, the scan driver 1921 is coupled to the pixel units P(1,1) to P(X,Y) through a plurality of scan signal lines SL_1 to SL_2M, where M is a positive integer. In this embodiment, the pixel units in each row of the pixel array 1910 are coupled to the same two scan signal lines, and the pixel units in different rows of the pixel array 1910 are coupled to two different scan signal lines. For instance, as shown in FIG. 19, the pixel units in the first row of the pixel array 1910 are coupled to the same two scan signal lines SL_1 and SL_2. The pixel units in the second row of the pixel array 1910 are coupled to the same two scan signal lines SL_3 and SL_4.

In this embodiment, the data driver 1922 is coupled to the pixel units P(1,1) to P(X,Y) through the data signal lines DL_1 to DL_N, where N is a positive integer. The pixel units in each column of the pixel array 1910 are coupled to the same data signal line, and the pixel units in different columns of the pixel array 1910 are coupled to different data signal lines. For instance, as shown in FIG. 19, the pixel units in the first column of the pixel array 1910 are coupled to the same data signal line DL_1. The pixel units in the second column of the pixel array 1910 are coupled to the same data signal line DL_2.

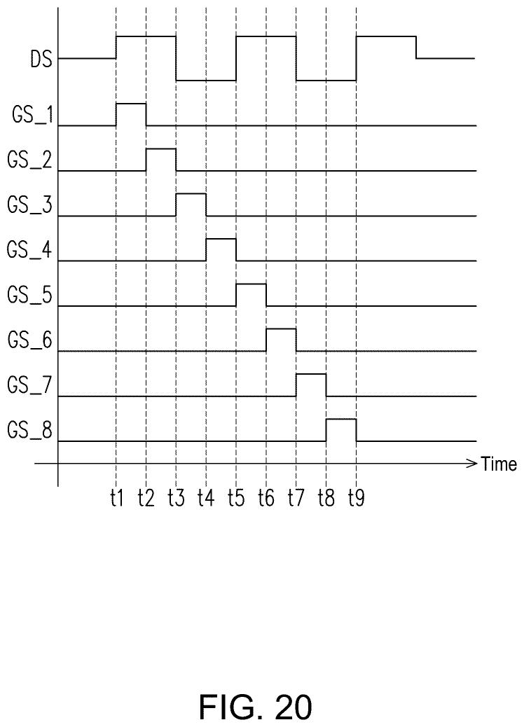

FIG. 20 is a waveform graph of a plurality of signals according to an embodiment of the disclosure. Referring to FIG. 19 and FIG. 20, in an embodiment, the data signal lines DL_1 to DL_N may be used to transmit the data signal DS as shown in FIG. 20. Further, the scan signal lines SL_1 to SL_8 may be used to transmit the scan signals GS_1 to GS_8 as shown in FIG. 20. During the period from time t1 to t9, the scan signals GS_1 to GS_8 may sequentially transmit scan pulses to sequentially turn on the pixel units from the first row to the fourth row. The scan driver 1921 sequentially drives the pixel units from the first row to the fourth row through the scan signal lines SL_1 to SL_8 during a plurality of scan periods. The scan periods do not overlap with each other, and a total period of two of the scan periods used for scanning the same column of pixel units overlaps with the same data writing period. For instance, as shown in FIG. 20, the data writing period from time t1 to time t3 overlaps with the total period of the scan period from time t1 to time t2 and the scan period from time t2 to time t3. Accordingly, the display device 1900 may achieve a single scan direction. Further, according to the layout shown in FIG. 19, the pixel array 1910 may have a smaller pixel structure in the horizontal direction.

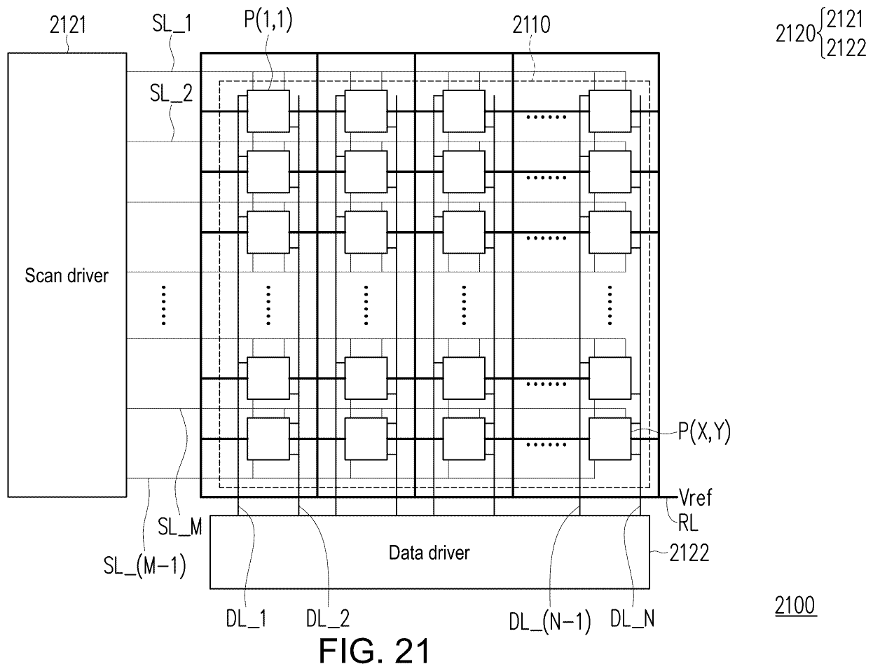

FIG. 21 is a circuit schematic diagram of a display device according to an embodiment of the disclosure. Referring to FIG. 21, the display device 100 of FIG. 1 may implement the circuit configuration of a display device 2100 of FIG. 21. In this embodiment, the display device 2100 includes a pixel array 2110 and a driving circuit 2120. The pixel array 2110 includes a plurality of pixel units P(1,1) to P(X,Y). The driving circuit 2120 includes a scan driver 2121 and a data driver 2122. The pixel units P(1,1) to P(X,Y) of the pixel array 2110 are coupled to the reference voltage line RL to receive the reference voltage Vref. The display device 2100 is an HGD pixel design.

In this embodiment, the scan driver 2121 is coupled to the pixel units P(1,1) to P(X,Y) through a plurality of scan signal lines SL_1 to SL_(M+1). In this embodiment, the pixel units P(1,1) to P(X,Y) in each row of the pixel array 2110 are coupled to the same two scan signal lines, and the pixel units in any two adjacent rows of the pixel array 2110 share the same scan signal line. For instance, as shown in FIG. 21, the pixel units in the first row of the pixel array 2110 are coupled to the same two scan signal lines SL_1 and SL_2. The pixel units in the second row of the pixel array 2110 are coupled to the same two scan signal lines SL_2 and SL_3.

In this embodiment, the data driver 2122 is coupled to the pixel units P(1,1) to P(X,Y) through a plurality of data signal lines DL_1 to DL_2N. The pixel units in each column of the pixel array 2110 are coupled to the same two data signal lines, and the pixel units in different columns of the pixel array 2110 are coupled to two different data signal lines. For instance, as shown in FIG. 21, the pixel units in the first column of the pixel array 2110 are coupled to the data signal line DL_1 and the data signal line DL_2. The pixel units in the second column of the pixel array 1910 are coupled to the data signal line DL_3 and the data signal line DL_4.

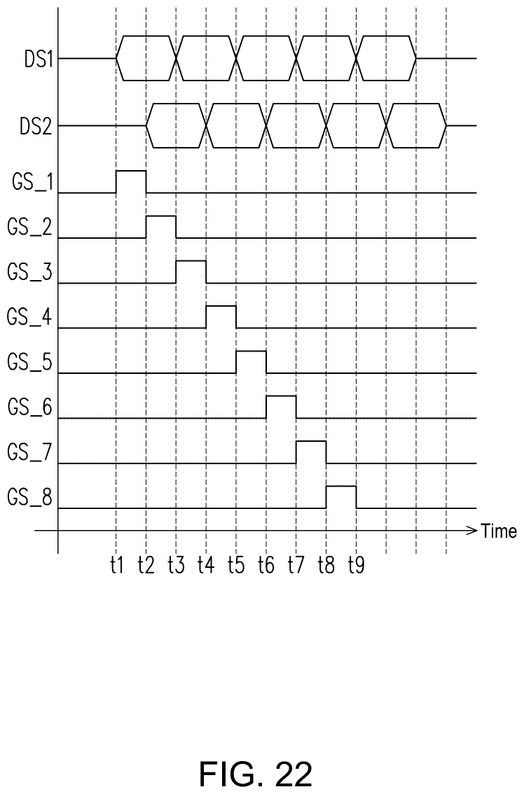

FIG. 22 is a waveform graph of a plurality of signals according to an embodiment of the disclosure. Referring to FIG. 21 and FIG. 22, in an embodiment, the odd-numbered data signal lines DL_1 to DL_(N−1) may be used to transmit the data signal DS1 as shown in FIG. 22. The even-numbered data signal lines DL_2 to DL_N may be used to transmit the data signal DS2 as shown in FIG. 22. Further, the scan signal lines SL_1 to SL_8 may be used to transmit the scan signals GS_1 to GS_8 as shown in FIG. 22. During the period from time t1 to t9, the scan signals GS_1 to GS_8 may sequentially transmit scan pulses to sequentially drive the pixel units from the first row to the fourth row. The scan driver 2121 sequentially drives the pixel units P(1,1) to P(X,Y) through the scan signal lines SL_1 to SL_8 during a plurality of scan periods. The scan periods do not overlap with each other, and the two scan periods for scanning the same column of pixel units overlap with two adjacent data writing periods. The two adjacent data writing periods are partially overlapping. For instance, as shown in FIG. 22, the scan period from time t1 to time t2 and the scan period from time t2 to time t3 overlap with the data writing period of the data signal DS1 from time t1 to time t3 and the data writing period of the data signal DS2 from time t2 to time t4. The data writing period of the data signal DS1 from time t1 to time t3 and the data writing period of the data signal DS2 from time t2 to time t4 are partially overlapping. In this regard, the display device 2100 may write to the same pixel unit through two data lines in different phases, and the pixel units in two adjacent columns may share the same scan line, so as to charge the pixel units in two adjacent columns, and the charging time of the pixel units may thus be extended.

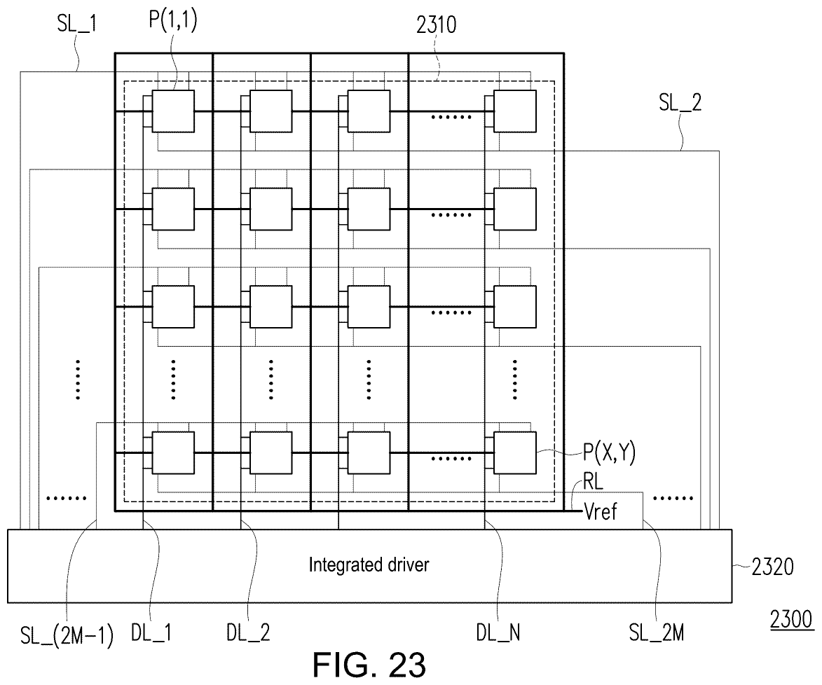

FIG. 23 is a circuit schematic diagram of a display device according to an embodiment of the disclosure. Referring to FIG. 23, the display device 100 of FIG. 1 may implement the circuit configuration of a display device 2300 as shown in FIG. 23. In this embodiment, the display device 2300 includes a pixel array 2310 and an integrated driver 2320 (i.e., an integrated driving circuit). The pixel array 2310 includes a plurality of pixel units P(1,1) to P(X,Y). The pixel units P(1,1) to P(X,Y) of the pixel array 2310 are coupled to the reference voltage line RL to receive the reference voltage Vref. In this embodiment, the integrated driver 2320 is coupled to the pixel units P(1,1) to P(X,Y) through a plurality of scan signal lines SL_1 to SL_2M and a plurality of data signal lines DL_1 to DL_N.

In this embodiment, a plurality of pixel units in each row of the pixel array 2310 are coupled to the same two scan signal lines, and a plurality of pixel units in different rows of the pixel array 2310 are coupled to two different scan signal lines. For instance, as shown in FIG. 23, a plurality of pixel units in the first row of the pixel array 2310 are coupled to the scan signal lines SL_1 and SL_2. A plurality of pixel units in the second row of the pixel array 2310 are coupled to the scan signal lines SL_3 and SL_4.

In this embodiment, a plurality of pixel units in each column of the pixel array 2310 are coupled to the same data signal line, and a plurality of pixel units in different columns of the pixel array 2310 are coupled to different data signal lines. For instance, as shown in FIG. 23, a plurality of pixel units in the first column of the pixel array 2310 are coupled to the data signal line DL_1. A plurality of pixel units in the second column of the pixel array 2310 are coupled to the data signal line DL_2.

In this embodiment, the description of the scan method and the data writing method of the display device 2300 may refer to the description of the embodiment of FIG. 20 above and thus is not repeated in detail herein. The display device 2300 of this embodiment may implement the functions of scan driving and data writing through the integrated driver 2320.

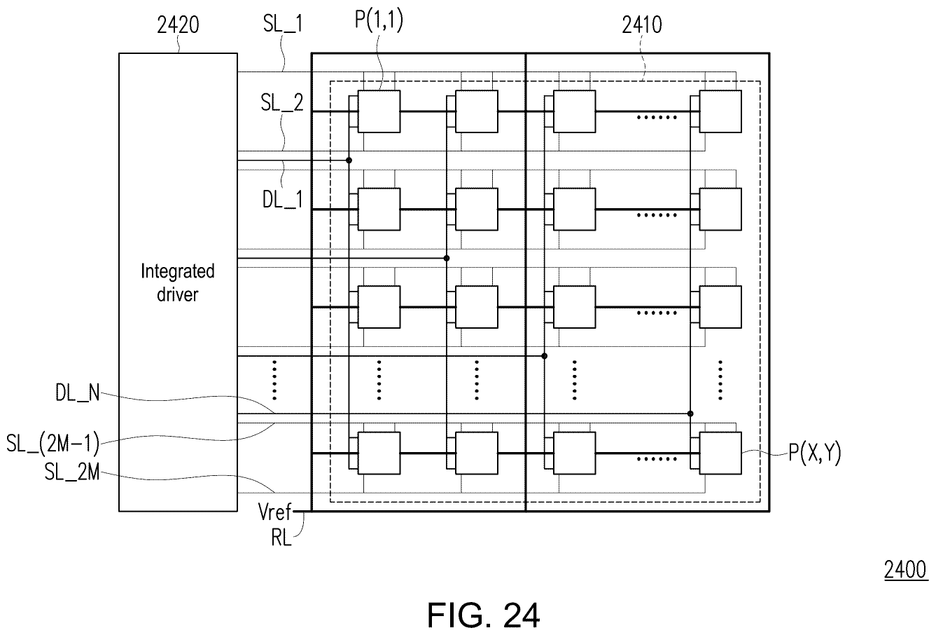

FIG. 24 is a circuit schematic diagram of a display device according to an embodiment of the disclosure. Referring to FIG. 24, the display device 100 of FIG. 1 may implement the circuit configuration of a display device 2400 as shown in FIG. 24. In this embodiment, the display device 2400 includes a pixel array 2410 and an integrated driver 2420 (i.e., an integrated driving circuit). The pixel array 2410 includes a plurality of pixel units P(1,1) to P(X,Y). The pixel units P(1,1) to P(X,Y) of the pixel array 2410 are coupled to the reference voltage line RL to receive the reference voltage Vref. In this embodiment, the integrated driver 2420 is coupled to the pixel units P(1,1) to P(X,Y) through a plurality of scan signal lines SL_1 to SL_2M and a plurality of data signal lines DL_1 to DL_N.

In this embodiment, a plurality of pixel units in each row of the pixel array 2410 are coupled to the same two scan signal lines, and a plurality of pixel units in different rows of the pixel array 2410 are coupled to two different scan signal lines. For instance, as shown in FIG. 24, a plurality of pixel units in the first row of the pixel array 2410 are coupled to the scan signal lines SL_1 and SL_2. A plurality of pixel units in the second row of the pixel array 2410 are coupled to the scan signal lines SL_3 and SL_4.

In this embodiment, a plurality of pixel units in each column of the pixel array 2410 are coupled to the same data signal line, and a plurality of pixel units in different columns of the pixel array 2410 are coupled to different data signal lines. It is worth noting that the integrated driver 2420 is coupled to a plurality of pixel units P(1,1) to P(X,Y) in different columns of the pixel array 2410 through the data signal lines DL_1 to DL_N in a T-type connection manner. For instance, as shown in FIG. 24, a plurality of pixel units in the first column of the pixel array 2410 are coupled to the data signal line DL_1, and the integrated driver 2420 is coupled to a plurality of pixel units in the first column of the pixel array 2410 through the data signal line DL_1 in a T-type connection manner. A plurality of pixel units in the second column of the pixel array 2410 are coupled to the data signal line DL_2, and the integrated driver 2420 is coupled to a plurality of pixel units in the second column of the pixel array 2410 through the data signal line DL_2 in a T-type connection manner.

In this embodiment, the description of the scan manner and the data writing manner of the display device 2400 may refer to the description of the embodiment of FIG. 20 above and thus is not repeated in detail herein. The display device 2400 of this embodiment may implement the functions of scan driving and data writing through the integrated driver 2420 and may save a trace area of the data signal lines through the T-type connection manner. In this way, the display device 2400 may have a smaller volume and may be applicable to narrow bezel applications (e.g., e-readers or notebook computers).

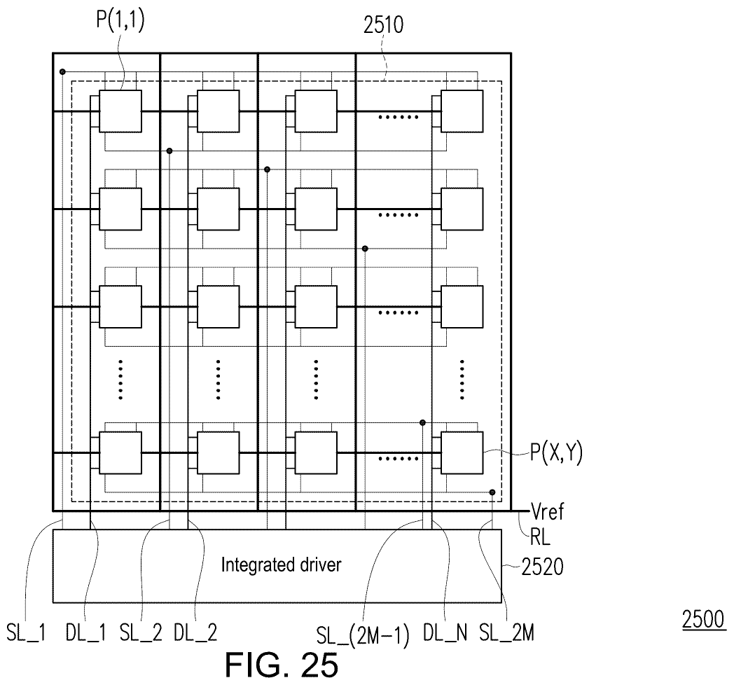

FIG. 25 is a circuit schematic diagram of a display device according to an embodiment of the disclosure. Referring to FIG. 25, the display device 100 of FIG. 1 may implement the circuit configuration of a display device 2500 as shown in FIG. 25. In this embodiment, the display device 2500 includes a pixel array 2510 and an integrated driver 2520 (i.e., an integrated driving circuit). The pixel array 2510 includes a plurality of pixel units P(1,1) to P(X,Y). The pixel units P(1,1) to P(X,Y) of the pixel array 2510 are coupled to the reference voltage line RL to receive the reference voltage Vref. In this embodiment, the integrated driver 2520 is coupled to the pixel units P(1,1) to P(X,Y) through a plurality of scan signal lines SL_1 to SL_2M and a plurality of data signal lines DL_1 to DL_N.

In this embodiment, a plurality of pixel units in each row of the pixel array 2510 are coupled to the same two scan signal lines, and a plurality of pixel units in different rows of the pixel array 2510 are coupled to two different scan signal lines. It is worth noting that the integrated driver 2520 is coupled to a plurality of pixel units P(1,1) to P(X,Y) in different columns of the pixel array 2510 through the scan signal lines SL_1 to SL_2M in a T-type connection manner. For instance, as shown in FIG. 25, a plurality of pixel units in the first row of the pixel array 2510 are coupled to the scan signal lines SL_1 and SL_2, and the integrated driver 2520 is coupled to a plurality of pixel units in the first row of the pixel array 2510 through the scan signal lines SL_1 and SL_2 in a T-type connection manner. A plurality of pixel units in the second row of the pixel array 2510 are coupled to the scan signal lines SL_3 and SL_4, and the integrated driver 2520 is coupled to a plurality of pixel units in the second row of the pixel array 2510 through the scan signal lines SL_3 and SL_4 in a T-type connection manner.

In this embodiment, a plurality of pixel units in each column of the pixel array 2510 are coupled to the same data signal line, and a plurality of pixel units in different columns of the pixel array 2510 are coupled to different data signal lines. For instance, as shown in FIG. 25, a plurality of pixel units in the first column of the pixel array 2510 are coupled to the data signal line DL_1. A plurality of pixel units in the second column of the pixel array 2510 are coupled to the data signal line DL_2.

In this embodiment, description of the scan method and the data writing method of the display device 2500 may refer to the description of the embodiment of FIG. 20 above and thus is not repeated in detail herein. The display device 2500 of this embodiment may implement the functions of scan driving and data writing through the integrated driver 2520 and may save the trace area of the scan signal lines through the T-type connection manner. In this way, the display device 2500 may have a smaller volume and may be suitable for elongated display applications (e.g., signage).

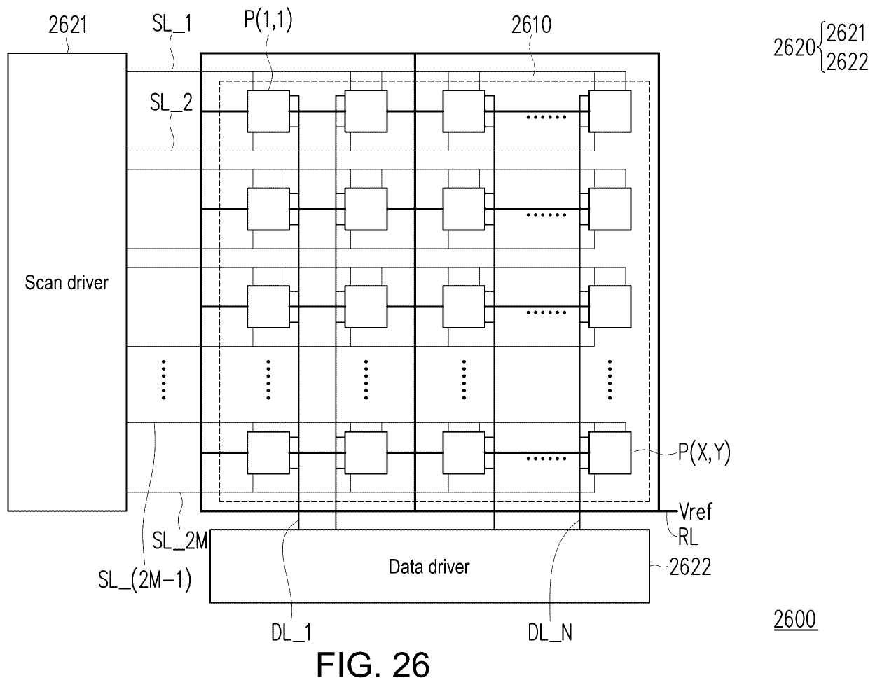

FIG. 26 is a circuit schematic diagram of a display device according to an embodiment of the disclosure. Referring to FIG. 26, the display device 100 of FIG. 1 may implement the circuit configuration of a display device 2600 as shown in FIG. 26. In this embodiment, the display device 2600 includes a pixel array 2610 and a driving circuit 2620. The pixel array 2610 includes a plurality of pixel units P(1,1) to P(X,Y). The driving circuit 2620 includes a scan driver 2621 and a data driver 2622. The pixel units P(1,1) to P(X,Y) of the pixel array 2610 are coupled to the reference voltage line RL to receive the reference voltage Vref. It is worth noting that, as shown in FIG. 26, a plurality of pixel units in some adjacent two columns (except for the first column and the last column) of the pixel array 2610 are coupled to the same reference voltage line RL.

In this embodiment, the scan driver 2621 is coupled to the pixel units P(1,1) to P(X,Y) through a plurality of scan signal lines SL_1 to SL_2M. In this embodiment, a plurality of pixel units in each row of the pixel array 2610 are coupled to the same two scan signal lines, and a plurality of pixel units in different rows of the pixel array 2610 are coupled to two different scan signal lines. For instance, as shown in FIG. 26, a plurality of pixel units in the first row of the pixel array 2610 are coupled to the same two scan signal lines SL_1 and SL_2. A plurality of pixel units in the second row of the pixel array 2610 are coupled to the same two scan signal lines SL_3 and SL_4.

In this embodiment, the data driver 2622 is coupled to the pixel units P(1,1) to P(X,Y) through a plurality of data signal lines DL_1 to DL_N. A plurality of pixel units in each column of the pixel array 2610 are coupled to the same data signal line, and a plurality of pixel units in different columns of the pixel array 2610 are coupled to different data signal lines. It is worth noting that, as shown in FIG. 26, every two of the data signal lines DL_1 to DL_N are disposed between the corresponding two columns of pixel units coupled thereto in the pixel array 2610. For instance, as shown in FIG. 26, a plurality of pixel units in the first column of the pixel array 2610 are coupled to the same data signal line DL_1. A plurality of pixel units in the second column of the pixel array 2610 are coupled to the same data signal line DL_2. Further, the data signal lines DL_1 and DL_2 are disposed between a plurality of pixel units in the first column and a plurality of pixel units in the second column in the pixel array 2610.

In this embodiment, the description of the scan method and the data writing method of the display device 2500 may refer to the description of the embodiment of FIG. 20 above and thus is not repeated in detail herein. Based on the above configuration of the data signal lines, the display device 2600 of this embodiment may have higher flexibility in pixel design, so that higher panel specifications, such as higher resolution or pixel density, may be achieved.

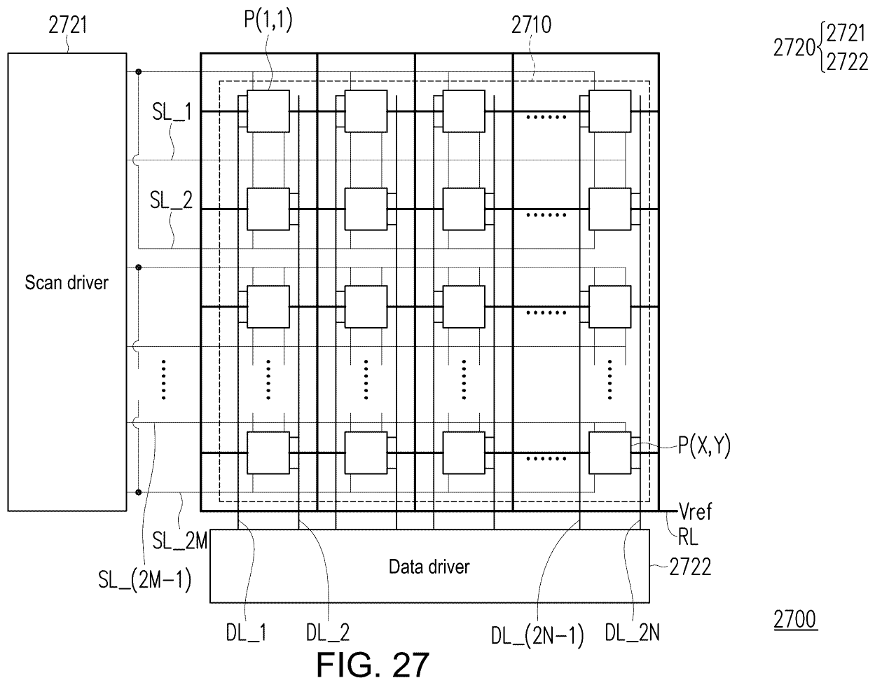

FIG. 27 is a circuit schematic diagram of a display device according to an embodiment of the disclosure. Referring to FIG. 27, the display device 100 of FIG. 1 may implement the circuit configuration of a display device 2700 of FIG. 27. In this embodiment, the display device 2700 includes a pixel array 2710 and a driving circuit 2720. The pixel array 2710 includes a plurality of pixel units P(1,1) to P(X,Y). The driving circuit 2720 includes a scan driver 2721 and a data driver 2722. The pixel units P(1,1) to P(X,Y) of the pixel array 2710 are coupled to the reference voltage line RL to receive the reference voltage Vref. The display device 2700 is an HGD pixel design.

In this embodiment, the scan driver 2721 is coupled to the pixel units P(1,1) to P(X,Y) through a plurality of scan signal lines SL_1 to SL_2M. In this embodiment, a plurality of pixel units in each row of the pixel array 2710 are coupled to the same two scan signal lines, and a plurality of pixel units in any two adjacent rows of the pixel array 2710 share the trace of odd-numbered scan signal lines. For instance, as shown in FIG. 27, a plurality of pixel units in the first row of the pixel array 2710 are coupled to the same two scan signal lines SL_1 and SL_2. A plurality of pixel units in the second row of the pixel array 2710 are also coupled to the same two scan signal lines SL_1 and SL_2. The first row and the second row of the pixel array 2710 share the trace of the scan signal line SL_1.

In this embodiment, the data driver 2722 is coupled to a plurality of pixel units P(1,1) to P(X,Y) through a plurality of data signal lines DL_1 to DL_2N. A plurality of pixel units in each column of the pixel array 2710 are coupled to the same two data signal lines, and a plurality of pixel units in the same column of the pixel array 2710 are alternately coupled to two different data signal lines. For instance, as shown in FIG. 27, the pixel units in the first row of the first column of the pixel array 2710 are coupled to the data signal line DL_1, and the pixel units in the second row of the first column of the pixel array 2710 are coupled to the data signal line DL_2. The pixel units in the first row of the second column of the pixel array 2710 are coupled to the data signal line DL_3, and the pixel units in the second row of the second column of the pixel array 2710 are coupled to the data signal line DL_4.

In this embodiment, a plurality of pixel units in two adjacent rows may share the same two scan lines to charge a plurality of pixel units in the two adjacent rows, so that the charging time of the pixel units may be extended.

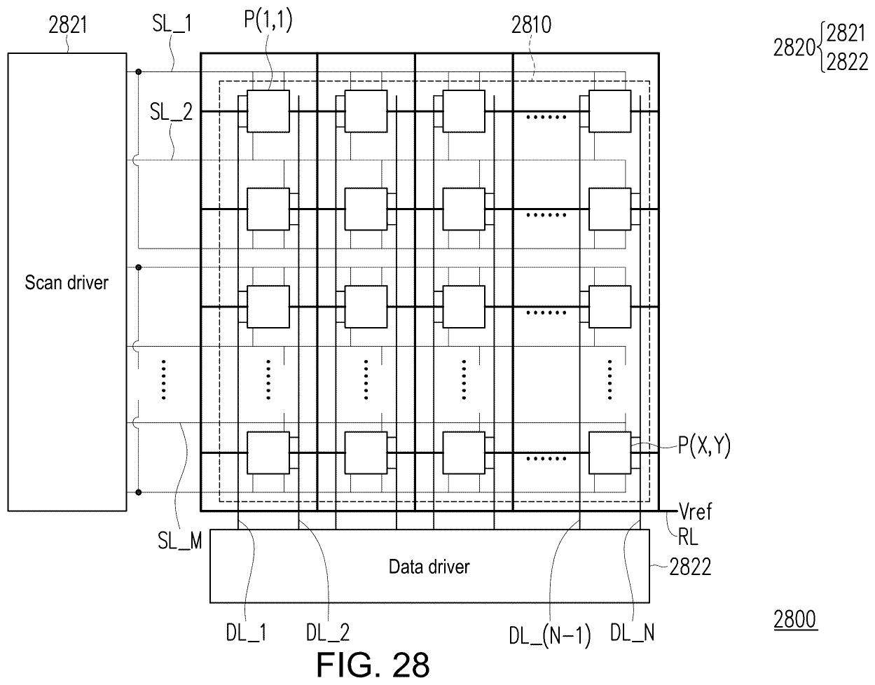

FIG. 28 is a circuit schematic diagram of a display device according to an embodiment of the disclosure. The display device 100 of FIG. 1 may implement the circuit configuration of a display device 2800 of FIG. 28. In this embodiment, the display device 2800 includes a pixel array 2810 and a driving circuit 2820. The pixel array 2810 includes a plurality of pixel units P(1,1) to P(X,Y). The driving circuit 2820 includes a scan driver 2821 and a data driver 2822. The pixel units P(1,1) to P(X,Y) of the pixel array 2810 are coupled to the reference voltage line RL to receive the reference voltage Vref. The display device 2800 is an HGD pixel design.

In this embodiment, the scan driver 2821 is coupled to the pixel units P(1,1) to P(X,Y) through a plurality of scan signal lines SL_1 to SL_2M. In this embodiment, a plurality of pixel units in each row of the pixel array 2810 are coupled to the same two scan signal lines, and a plurality of pixel units in any two adjacent rows of the pixel array 2810 share the traces of even-numbered scan signal lines. For instance, as shown in FIG. 28, a plurality of pixel units in the first row of the pixel array 2810 are coupled to the same two scan signal lines SL_1 and SL_2. A plurality of pixel units in the second row of the pixel array 2810 are also coupled to the same two scan signal lines SL_1 and SL_2. The first row and the second row of the pixel array 2810 share the trace of the scan signal line SL_2.

In this embodiment, the data driver 2822 is coupled to a plurality of pixel units P(1,1) to P(X,Y) through a plurality of data signal lines DL_1 to DL_N. A plurality of pixel units in each column of the pixel array 2810 are coupled to the same two data signal lines, and a plurality of pixel units in different columns of the pixel array 2810 are coupled to two different data signal lines. For instance, as shown in FIG. 28, a plurality of pixel units in the first column of the pixel array 2810 are coupled to the data signal line DL_1 and the data signal line DL_2. A plurality of pixel units in the second column of the pixel array 2810 are coupled to the data signal line DL_3 and the data signal line DL_4.

In this embodiment, the display device 2800 may write to the same pixel unit through two data lines in different phases, and a plurality of pixel units in two adjacent rows may share the same two scan lines to charge a plurality of pixel units in the two adjacent rows, so that the charging time of the pixel units may be extended.

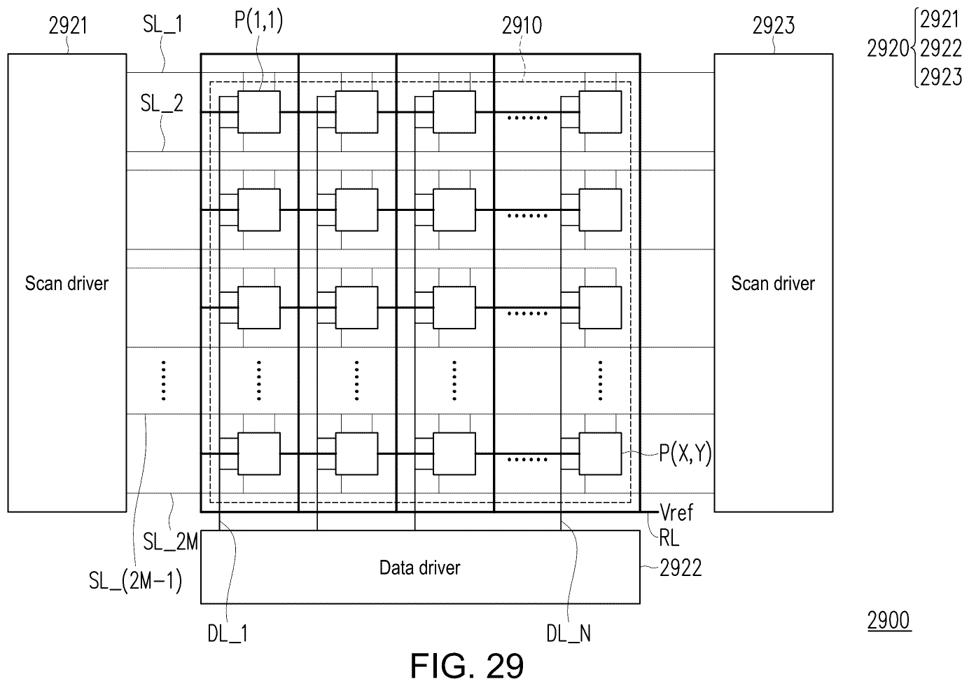

FIG. 29 is a circuit schematic diagram of a display device according to an embodiment of the disclosure. Referring to FIG. 29, the display device 100 of FIG. 1 may implement the circuit configuration of a display device 2900 of FIG. 29. In this embodiment, the display device 2900 includes a pixel array 2910 and a driving circuit 2920. The pixel array 2910 includes a plurality of pixel units P(1,1) to P(X,Y). The driving circuit 2920 includes scan drivers 2921 and 2923 and a data driver 2922. The pixel units P(1,1) to P(X,Y) of the pixel array 2910 are coupled to the reference voltage line RL to receive the reference voltage Vref.

In this embodiment, the scan drivers 2921 and 2923 are disposed on two sides of the pixel array 2910. The scan drivers 2921 and 2923 are coupled to the pixel units P(1,1) to P(X,Y) through a plurality of scan signal lines SL_1 to SL_2M. In this embodiment, a plurality of pixel units in each row of the pixel array 2910 are coupled to the same two scan signal lines, and a plurality of pixel units in different rows of the pixel array 2910 are coupled to two different scan signal lines. For instance, as shown in FIG. 29, a plurality of pixel units in the first row of the pixel array 2910 are coupled to the same two scan signal lines SL_1 and SL_2. A plurality of pixel units in the second row of the pixel array 2910 are coupled to the same two scan signal lines SL_3 and SL_4.

In this embodiment, the data driver 2922 is coupled to the pixel units P(1,1) to P(X,Y) through a plurality of data signal lines DL_1 to DL_N. A plurality of pixel units in each column of the pixel array 2910 are coupled to the same data signal line, and a plurality of pixel units in different columns of the pixel array 2910 are coupled to different data signal lines. For instance, as shown in FIG. 29, a plurality of pixel units in the first column of the pixel array 2910 are coupled to the same data signal line DL_1. A plurality of pixel units in the second column of the pixel array 2910 are coupled to the same data signal line DL_2.

In this embodiment, the description of the scan method and the data writing method of the display device 2900 may refer to the description of the embodiment of FIG. 20 above and thus is not repeated in detail herein. The display device 2900 of this embodiment may implement the scan drivers 2921 and 2923 through a gate on array (GOA) or a dedicated scan circuit.

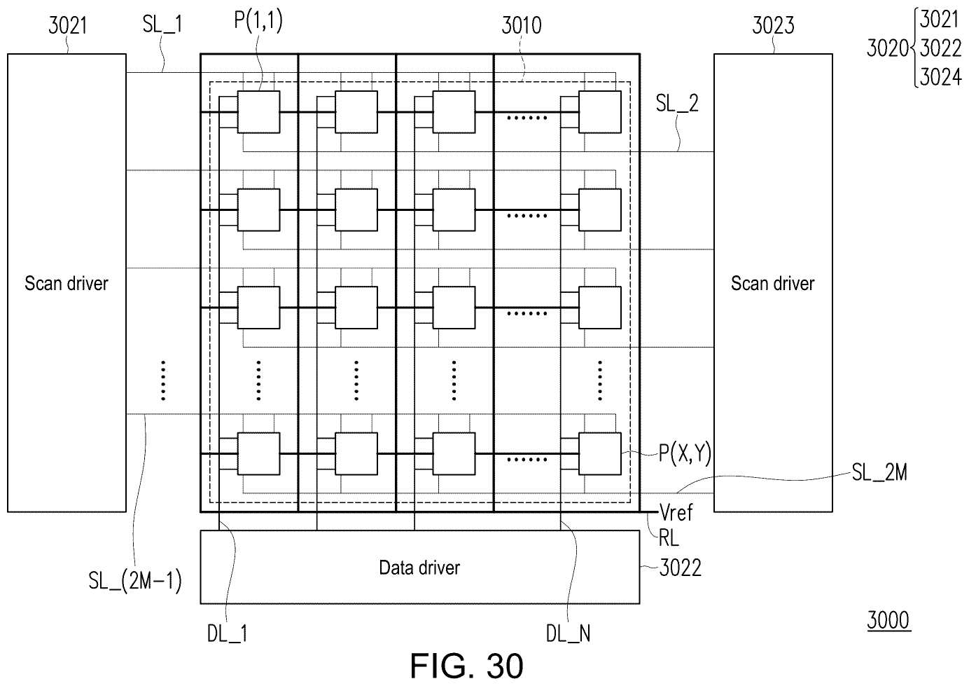

FIG. 30 is a circuit schematic diagram of a display device according to an embodiment of the disclosure. Referring to FIG. 30, the display device 100 of FIG. 1 may implement the circuit configuration of a display device 3000 as shown in FIG. 30. In this embodiment, the display device 3000 includes a pixel array 3010 and a driving circuit 3020. The pixel array 3010 includes a plurality of pixel units P(1,1) to P(X,Y). The driving circuit 3020 includes scan drivers 3021 and 3023 and a data driver 3022. The pixel units P(1,1) to P(X,Y) of the pixel array 3010 are coupled to the reference voltage line RL to receive the reference voltage Vref.

In this embodiment, the scan drivers 3021 and 3023 are disposed on two sides of the pixel array 3010. The scan drivers 3021 and 3023 are coupled to the pixel units P(1,1) to P(X,Y) through a plurality of scan signal lines SL_1 to SL_2M. In this embodiment, the scan driver 3021 is coupled to a plurality of pixel units through a plurality of odd-numbered scan signal lines SL_1 and SL_3 to SL_(2M−1). The scan driver 3021 is coupled to a plurality of pixel units through a plurality of even-numbered scan signal lines SL_2 and SL_4 to SL_2M. A plurality of pixel units in each row of the pixel array 3010 are coupled to the same one odd-numbered scan signal line and one even-numbered scan signal line, and a plurality of pixel units in different rows of the pixel array 3010 are coupled to two different scan signal lines. For instance, as shown in FIG. 30, a plurality of pixel units in the first row of the pixel array 3010 are coupled to the same one odd-numbered scan signal line SL_1 and one even-numbered scan signal line SL_2. A plurality of pixel units in the second row of the pixel array 3010 are coupled to the same one odd-numbered scan signal line SL_3 and one even-numbered scan signal line SL_4.

In this embodiment, the data driver 3022 is coupled to the pixel units P(1,1) to P(X,Y) through a plurality of data signal lines DL_1 to DL_N, where N is a positive integer. A plurality of pixel units in each column of the pixel array 3010 are coupled to the same data signal line, and a plurality of pixel units in different columns of the pixel array 3010 are coupled to different data signal lines. For instance, as shown in FIG. 30, a plurality of pixel units in the first column of the pixel array 3010 are coupled to the same data signal line DL_1. A plurality of pixel units in the second column of the pixel array 3010 are coupled to the same data signal line DL_2.

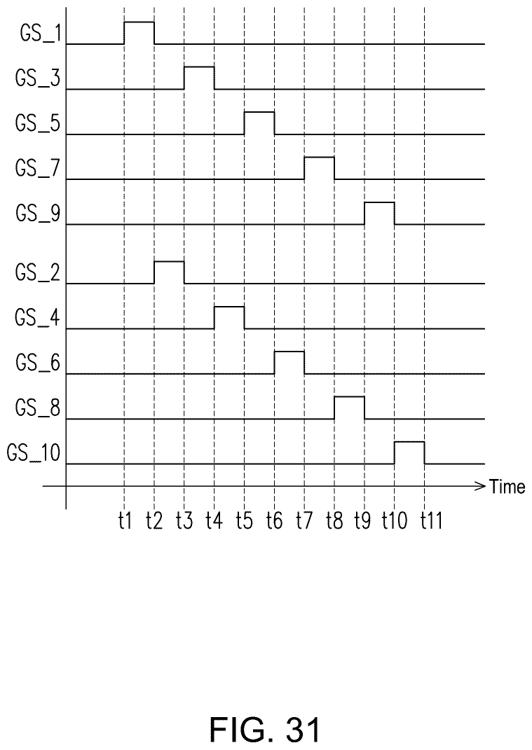

FIG. 31 is a waveform graph of a plurality of signals according to an embodiment of the disclosure. Referring to FIG. 30 and FIG. 31, in an embodiment, the scan signal lines SL_1 to SL_10 may be used to transmit the scan signals GS_1 to GS_10 as shown in FIG. 31. The scan driver 3021 and the scan driver 3023 may perform forward scanning. During the period from time t1 to t11, the scan driver 3021 and the scan driver 3023 alternately drive a plurality of pixel units in different rows through the scan signal lines SL_1 to SL_10 during a plurality of scan periods, and the scan periods do not overlap with each other. For instance, as shown in FIG. 31, during the scan period from time t1 to time t2, the scan driver 3021 drives a plurality of pixel units in the first row through the scan signal GS_1. Next, during the scan period from time t2 to time t3, the scan driver 3023 drives a plurality of pixel units in the first row through the scan signal GS_2. Next, during the scan period from time t3 to time t4, the scan driver 3021 drives a plurality of pixel units in the second row through the scan signal GS_3. Next, during the scan period from time t4 to time t5, the scan driver 3023 drives a plurality of pixel units in the second row through the scan signal GS_4. By analogy, the display device 1900 may implement forward scanning of a plurality of pixel units in the first row to the fifth row.

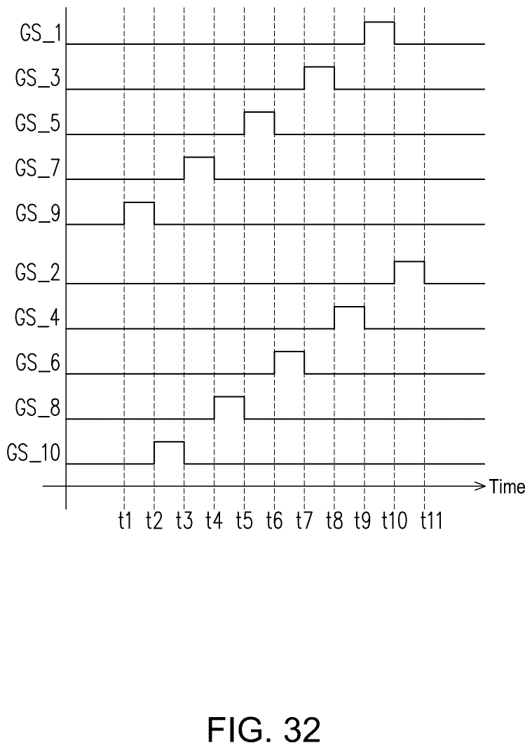

FIG. 32 is a waveform graph of a plurality of signals according to an embodiment of the disclosure. Referring to FIG. 30 and FIG. 31, in an embodiment, the scan signal lines SL_1 to SL_10 may be used to transmit the scan signals GS_1 to GS_10 as shown in FIG. 31. The scan driver 3021 and the scan driver 3023 may perform reverse (reverse order) scanning. During the period from time t1 to t11, the scan driver 3021 and the scan driver 3023 alternately drive a plurality of pixel units in different rows through the scan signal lines SL_1 to SL_10 during a plurality of scan periods, and the scan periods do not overlap with each other. For instance, as shown in FIG. 32, during the scan period from time t1 to time t2, the scan driver 3021 drives a plurality of pixel units in the fifth row through the scan signal GS_9. Next, during the scan period from time t2 to time t3, the scan driver 3023 drives a plurality of pixel units in the fifth row through the scan signal GS_10. Next, during the scan period from time t3 to time t4, the scan driver 3021 drives a plurality of pixel units in the fourth row through the scan signal GS_7. Next, during the scan period from time t4 to time t5, the scan driver 3023 drives a plurality of pixel units in the fourth row through the scan signal GS_8. By analogy, the display device 1900 may implement reverse scanning of a plurality of pixel units in the fifth row to the first row.

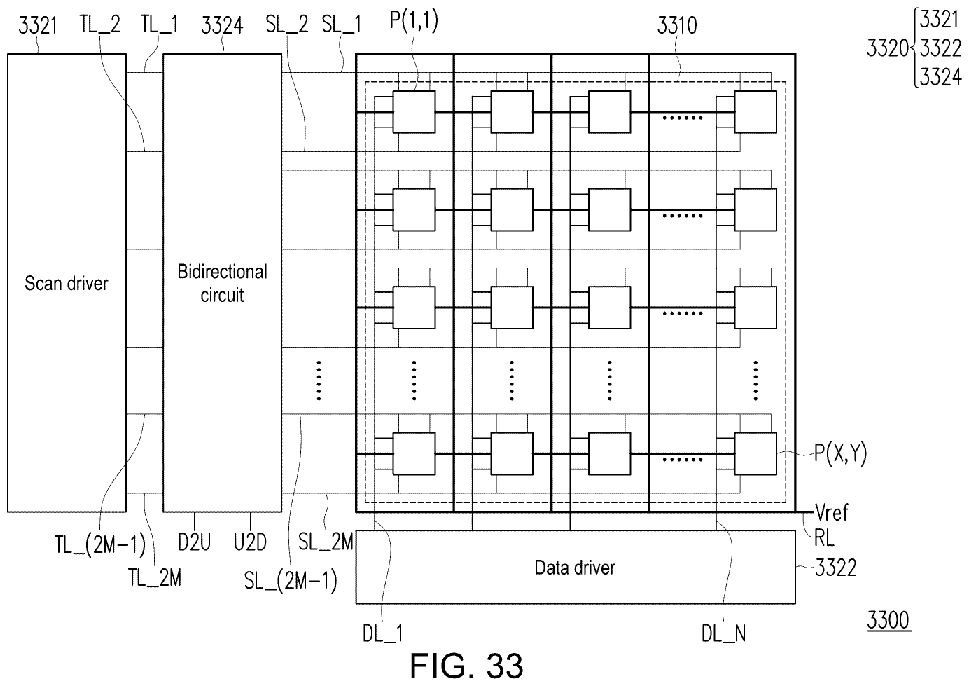

FIG. 33 is a circuit schematic diagram of a display device according to an embodiment of the disclosure. Referring to FIG. 33, the display device 100 of FIG. 1 may implement the circuit configuration of a display device 3300 as shown in FIG. 33. In this embodiment, the display device 3300 includes a pixel array 3310 and a driving circuit 3320. The pixel array 3310 includes a plurality of pixel units P(1,1) to P(X,Y). The driving circuit 3320 includes a scan driver 3321, a data driver 3322, and a bidirectional circuit 3324. The pixel units P(1,1) to P(X,Y) of the pixel array 3310 are coupled to the reference voltage line RL to receive the reference voltage Vref.

In this embodiment, the bidirectional circuit 3324 is coupled to the pixel units P(1,1) to P(X,Y) through a plurality of scan signal lines SL_1 to SL_2M. The scan driver 3321 is coupled to the bidirectional circuit 3324 through a plurality of output signal lines TL_1 to TL_2M. In this embodiment, the bidirectional circuit 3324 may include a plurality of bidirectional units, and the bidirectional circuit 3324 is coupled to different adjacent two output signal lines and different adjacent two scan signal lines. For instance, as shown in FIG. 33, a plurality of pixel units in the first row of the pixel array 3310 are coupled to the same scan signal lines SL_1 and SL_2. A plurality of pixel units in the second row of the pixel array 3310 are coupled to the same scan signal lines SL_3 and SL_4.

In this embodiment, the data driver 3322 is coupled to the pixel units P(1,1) to P(X,Y) through a plurality of data signal lines DL_1 to DL_N. A plurality of pixel units in each column of the pixel array 3310 are coupled to the same data signal line, and a plurality of pixel units in different columns of the pixel array 3310 are coupled to different data signal lines. For instance, as shown in FIG. 33, a plurality of pixel units in the first column of the pixel array 3310 are coupled to the same data signal line DL_1. A plurality of pixel units in the second column of the pixel array 3310 are coupled to the same data signal line DL_2.

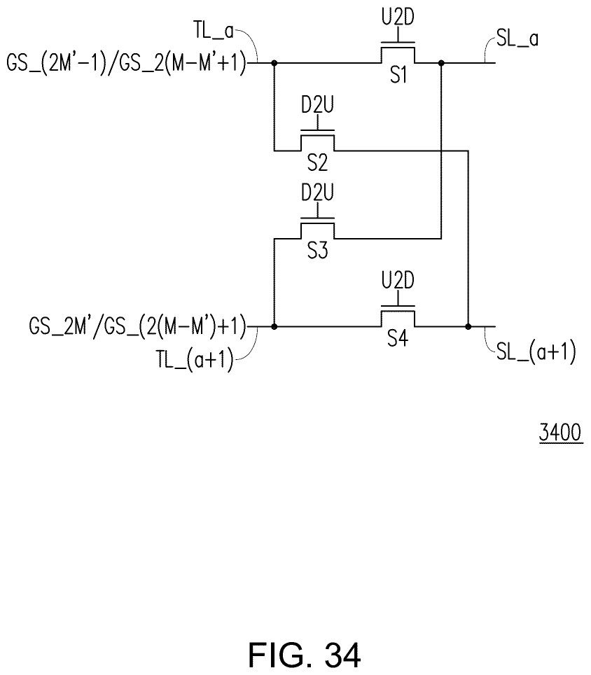

FIG. 34 is a circuit schematic diagram of a bidirectional circuit according to an embodiment of the disclosure. Referring to FIG. 33 and FIG. 34, each of the bidirectional units of the bidirectional circuit 3324 of FIG. 33 may implement the circuit architecture of a bidirectional unit 3400 as shown in FIG. 34. In this embodiment, output signal lines TL_a and TL_(a+1) and the scan signal lines including the scan signal lines SL_a and SL_(a+1) are taken as an example, where a is a positive integer between 1 and 2M. The bidirectional unit 3400 includes switches S1 to S4. The switches S1 to S4 may be N-type transistors, but the disclosure is not limited thereto. In an embodiment, at least one of the switches S1 to S4 may also be a P-type transistor, and the coupling relationship is correspondingly changed.

In this embodiment, a first terminal of the switch S1 is coupled to the output signal line TL_a. A second terminal of the switch S1 is coupled to the scan signal line SL_a. A control terminal of the switch S1 is coupled to a control signal U2D. A first terminal of the switch S2 is coupled to the output signal line TL_a. A second terminal of the switch S2 is coupled to the scan signal line SL_(a+1). A control terminal of the switch S2 is coupled to a control signal D2U. A first terminal of the switch S3 is coupled to the output signal line TL_(a+1). A second terminal of the switch S3 is coupled to the scan signal line SL_a. A control terminal of the switch S3 is coupled to the control signal D2U. A first terminal of the switch S4 is coupled to the output signal line TL_(a+1). A second terminal of the switch S3 is coupled to the scan signal line SL_(a+1). A control terminal of the switch S4 is coupled to the control signal U2D.

In this embodiment, the scan signal line SL_a may selectively output a scan signal GS_(2M′−1) or a scan signal GS_2(M−M′+1) to the pixel units of the corresponding row according to the result of the control signal U2D and the control signal D2U controlling the switch S1 and the switch S3, where M′ is between 1 and M. The scan signal line SL_(a+1) may selectively output a scan signal GS_2M′ or a scan signal GS_(2(M−M′)+1) to the pixel units of the corresponding row according to the result of the control signal U2D and the control signal D2U controlling the switch S2 and the switch S4. The bidirectional unit 3400 may implement the driving of the pixel units coupled to the scan signal lines SL_a and SL_(a+1) in sequence, or reversely driving the pixel units coupled to the scan signal lines SL_a and SL_(a+1).

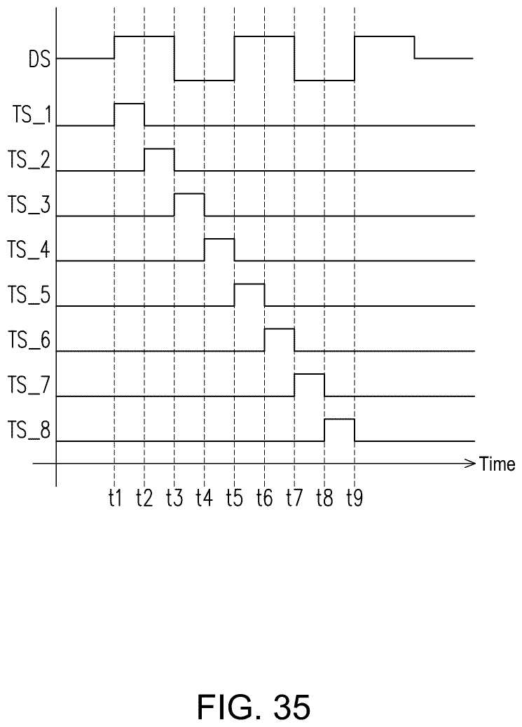

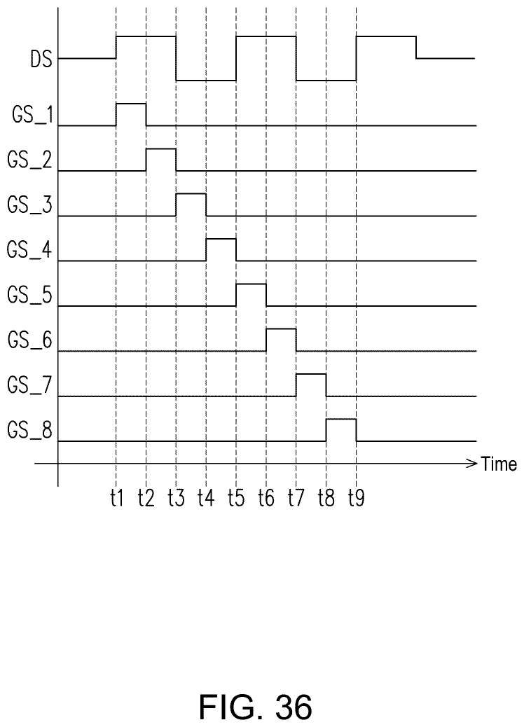

FIG. 35 is a waveform graph of a plurality of signals according to an embodiment of the disclosure. FIG. 36 is a waveform graph of a plurality of signals according to an embodiment of the disclosure. Referring to FIG. 33 to FIG. 36, in an embodiment, the bidirectional circuit 3324 includes a plurality of bidirectional units (e.g., the bidirectional unit 3400 shown in FIG. 34) coupled to the pixel units of different rows, and the bidirectional circuit 3324 may determine to sequentially drive the pixel units of multiple rows through the scan signal lines SL_1 to SL_2M according to the control signal U2D and the control signal D2U through the bidirectional units.

In an embodiment, the data signal lines DL_1 to DL_4 may be used to transmit the data signal DS as shown in FIG. 35. Further, the scan driver 3321 may output the scan signals TS_1 to TS_8 as shown in FIG. 35 to the bidirectional units through the output signal lines TL_1 to TL_8. During the period of time t1 to t9, the scan signals TS_1 to TS_8 may sequentially transmit scan pulses. The bidirectional units may sequentially output the scan pulses of the scan signals GS_1 to GS_8 through the scan signal lines SL_1 to SL_8 during the period of time t1 to t9 according to the control signal U2D and the control signal D2U. Therefore, the bidirectional circuit 3324 may sequentially drive the pixel units from the first row to the fourth row.

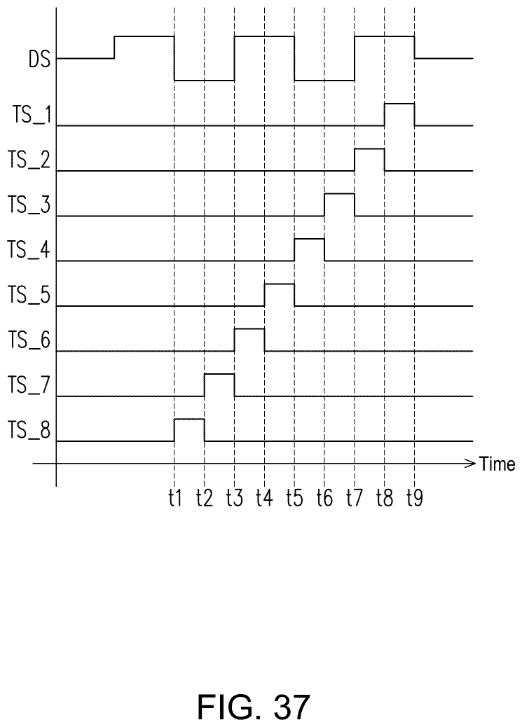

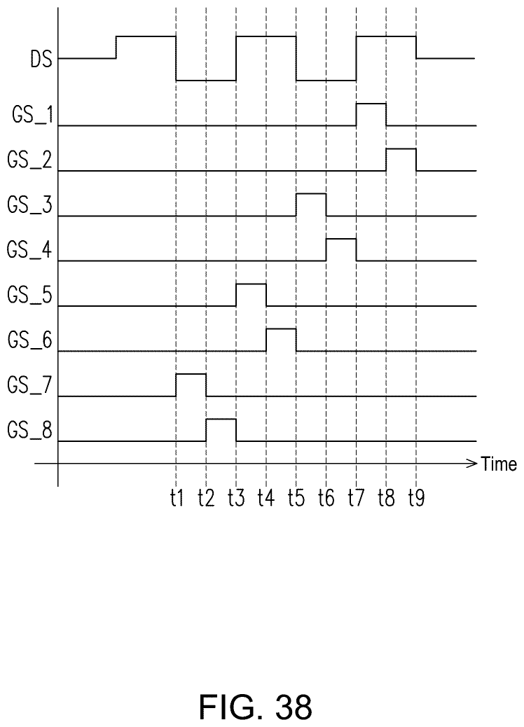

FIG. 37 is a waveform graph of a plurality of signals according to an embodiment of the disclosure. FIG. 38 is a waveform graph of a plurality of signals according to an embodiment of the disclosure. Referring to FIG. 33, FIG. 34, FIG. 37, and FIG. 38, in an embodiment, the bidirectional circuit 3324 may also determine to reversely drive the pixel units of multiple rows through the scan signal lines SL_1 to SL_2M according to the control signal U2D and the control signal D2U through the bidirectional units.

In an embodiment, the data signal lines DL_1 to DL_4 may be used to transmit the data signal DS as shown in FIG. 37. Further, the scan driver 3321 may output the scan signals TS_1 to TS_8 as shown in FIG. 37 to the bidirectional units through the output signal lines TL_1 to TL_8. During the period of time t1 to t9, the scan signals TS_1 to TS_8 may transmit scan pulses in a reverse order. Next, as shown in FIG. 38, the bidirectional units may output the scan signals GS_7, GS_8, GS_5, GS_6, GS_3, GS_4, GS_2, and GS_1 through the scan signal lines SL_1 to SL_8 during the period of time t1 to t9 according to the control signal U2D and the control signal D2U to reversely drive the pixel units from the first row to the fourth row.

It should be noted that the pixel units described in the above embodiments of FIG. 19 to FIG. 38 may implement the circuit architecture of the pixel unit 211 of the embodiment of FIG. 2. Therefore, the display devices of the embodiments of FIG. 19 to FIG. 38 may enable each pixel unit to receive two scan voltages and two data voltages according to the scan signals and the data signals transmitted by their respective wiring methods. As such, each pixel unit of the embodiments of FIG. 19 to FIG. 38 may achieve positive voltage and negative voltage with high voltage peaks through the equivalent bootstrap capacitor Cboost (as the operation method of the above embodiments of FIG. 3 and FIG. 4), so that the corresponding electrophoretic particles in the pixel unit 211 are effectively driven.

In view of the foregoing, in the disclosure, the display device may effectively implement the structures of the storage capacitor and the equivalent bootstrap capacitor through the design of the pixel structure and the layout structure. Further, the display device of the disclosure may implement various circuit layout designs suitable for different applications through the configuration of the scan signal lines and the data signal lines. In the disclosure, the display device may achieve positive voltage and negative voltage with high voltage peaks through the equivalent bootstrap capacitor, so that the corresponding electrophoretic particles in the pixel unit are effectively driven.

Although the disclosure has been disclosed above with embodiments, they are not intended to limit the disclosure. A person having ordinary skill in the art may make some modifications and refinements without departing from the spirit and scope of the disclosure. Therefore, the protection scope of the disclosure shall be defined by the appended claims.

What is claimed is:

1. A display device, comprising:
a pixel array, comprising a plurality of pixel units; and
a driving circuit, coupled to the pixel units through a plurality of scan signal lines and a plurality of data signal lines,
wherein each of the pixel units comprises:
a first transistor, coupled to a first node;
a second transistor, coupled to a second node;
a third transistor, coupled to the second node;
an equivalent bootstrap capacitor, coupled between the first node and the second node; and
an equivalent pixel capacitor, coupled between the first node and a reference voltage.

2. The display device according to claim 1, wherein the driving circuit comprises:
a scan driver, coupled to the pixel units through the scan signal lines,
wherein the pixel units of each row or every two adjacent rows of the pixel array are coupled to the same two scan signal lines, and the pixel units of different rows or two different adjacent rows of the pixel array are coupled to two different scan signal lines.

3. The display device according to claim 2, wherein the driving circuit further comprises:
another scan driver, coupled to the pixel units through the scan signal lines,
wherein the scan driver and the another scan driver are disposed on two sides of the pixel array.

4. The display device according to claim 2, wherein the scan driver sequentially drives the pixel units through the scan signal lines during a plurality of scan periods, the scan periods do not overlap with each other, and a total period of two of the scan periods for scanning the pixel units of a same column overlaps with a same data writing period.

5. The display device according to claim 1, wherein the driving circuit comprises:
a scan driver, coupled to the pixel units through the scan signal lines,
wherein the pixel units of each row of the pixel array are coupled to the same two scan signal lines, and the pixel units of any two adjacent rows of the pixel array share at least one scan signal line.

6. The display device according to claim 5, wherein the scan driver sequentially drives the pixel units through the scan signal lines during a plurality of scan periods, the scan periods do not overlap with each other, and two scan periods for scanning the pixel units of a same column overlap with two adjacent data writing periods, wherein the two adjacent data writing periods are partially overlapped.

7. The display device according to claim 1, wherein the driving circuit comprises:
a first scan driver, coupled to the pixel units through a plurality of odd-numbered scan signal lines of the scan signal lines; and
a second scan driver, coupled to the pixel units through a plurality of even-numbered scan signal lines of the scan signal lines,
wherein the pixel units of each row of the pixel array are coupled to the same one odd-numbered scan signal line and one even-numbered scan signal line, and the pixel units of different rows of the pixel array are coupled to two different scan signal lines.

8. The display device according to claim 7, wherein the first scan driver and the second scan driver alternately drive the pixel units through the scan signal lines during a plurality of scan periods, the scan periods do not overlap with each other.

9. The display device according to claim 1, wherein the driving circuit comprises:
a bidirectional circuit, coupled to the pixel units through the scan signal lines; and
a scan driver, coupled to the bidirectional circuit through a plurality of output signal lines,
wherein the bidirectional circuit comprises a plurality of bidirectional units, and the bidirectional units are coupled to two different adjacent output signal lines and two different adjacent scan signal lines.

10. The display device according to claim 9, wherein the output signal lines comprise a first output signal line and a second output signal line, and the scan signal lines comprise a first scan signal line and a second scan signal line,
wherein each of the bidirectional units comprises:
a first switch, wherein a first terminal of the first switch is coupled to the first output signal line, a second terminal of the first switch is coupled to the first scan signal line, and a control terminal of the first switch is coupled to a first control signal;
a second switch, wherein a first terminal of the second switch is coupled to the first output signal line, a second terminal of the second switch is coupled to the second scan signal line, and a control terminal of the second switch is coupled to a second control signal;
a third switch, wherein a first terminal of the third switch is coupled to the second output signal line, a second terminal of the third switch is coupled to the first scan signal line, and a control terminal of the third switch is coupled to the second control signal; and
a fourth switch, wherein a first terminal of the fourth switch is coupled to the second output signal line, a second terminal of the fourth switch is coupled to the second scan signal line, and a control terminal of the fourth switch is coupled to the first control signal.

11. The display device according to claim 10, wherein the bidirectional circuit determines to sequentially drive the pixel units or reversely drive the pixel units through the scan signal lines according to the first control signal and the second control signal.

12. The display device according to claim 1, wherein the driving circuit comprises:
a data driver, coupled to the pixel units through the data signal lines,
wherein the pixel units in each column of the pixel array are coupled to a same data signal line, and the pixel units in different columns of the pixel array are coupled to different data signal lines.

13. The display device according to claim 8, wherein every two of the data signal lines are disposed between corresponding two columns of pixel units coupled thereto in the pixel array.

14. The display device according to claim 8, wherein the pixel units in some adjacent two columns of the pixel array are coupled to a same reference voltage line.

15. The display device according to claim 1, wherein the driving circuit comprises:
a data driver, coupled to the pixel units through the data signal lines,
wherein the pixel units in each column of the pixel array are coupled to same two data signal lines, and the pixel units in different columns of the pixel array are coupled to two different data signal lines.

16. The display device according to claim 1, wherein the driving circuit comprises:
an integrated driver, coupled to the pixel units through the scan signal lines and the data signal lines,
wherein the pixel units in each row of the pixel array are coupled to same two scan signal lines, and the pixel units in different rows of the pixel array are coupled to two different scan signal lines,
wherein the pixel units in each column of the pixel array are coupled to a same data signal line, and the pixel units in different columns of the pixel array are coupled to different data signal lines.

17. The display device according to claim 16, wherein the integrated driver is coupled to the pixel units in different columns of the pixel array through the data signal lines in a T-shaped connection manner.

18. The display device according to claim 16, wherein the integrated driver is coupled to the pixel units in different rows of the pixel array through the scan signal lines in a T-shaped connection manner.

19. The display device according to claim 1, further comprising:
a substrate, wherein the pixel array is formed on the substrate,
wherein each of the pixel units further comprises a first metal layer, a first insulating layer, a second metal layer, a second insulating layer, a planarization layer, a pixel electrode layer and an upper electrode layer patterned and selectively formed above the substrate.

20. The display device according to claim 19, wherein each of the pixel units further comprises:
a pixel structure, comprising the equivalent bootstrap capacitor formed by the second metal layer, the second insulating layer, and the pixel electrode layer.

21. The display device according to claim 20, wherein the pixel structure further comprises a storage capacitor formed by the first metal layer, the first insulating layer, and the second metal layer.

22. The display device according to claim 20, wherein the pixel structure further comprises:
a first through hole, formed among the second metal layer, the second insulating layer, the planarization layer, and the pixel electrode layer.

23. The display device according to claim 22, wherein each of the pixel units further comprises:
a connection pad structure, comprising:
a second through hole, formed among the second metal layer, the second insulating layer, and the pixel electrode layer; and
a third through hole, formed among the first metal layer, the first insulating layer, the second insulating layer, and the pixel electrode layer.

24. The display device according to claim 22, wherein each of the pixel units further comprises:
a connection pad structure, comprising:
a second through hole, formed among the second metal layer, the second insulating layer, and the pixel electrode layer; and
a third through hole, formed among the first metal layer, the first insulating layer, and the second metal layer.

25. The display device according to claim 19, wherein each of the pixel units further comprises:
a pixel structure, comprising the equivalent bootstrap capacitor formed by the first metal layer, the first insulating layer, the second metal layer, the second insulating layer, and the pixel electrode layer.

26. The display device according to claim 25, wherein the pixel structure further comprises:
a first through hole, formed among the second metal layer, the second insulating layer, the planarization layer, and the pixel electrode layer; and
a second through hole, formed among the first metal layer, the first insulating layer, and the second metal layer.

27. The display device according to claim 25, wherein each of the pixel units further comprises:
a connection pad structure, comprising:
a third through hole, formed among the second metal layer, the second insulating layer, and the pixel electrode layer; and
a fourth through hole, formed among the first metal layer, the first insulating layer, and the second metal layer.

28. The display device according to claim 1, further comprising:
a substrate, wherein the pixel array is formed on the substrate;
wherein each of the pixel units further comprises a first metal layer, a first insulating layer, a second metal layer, a second insulating layer, a planarization layer, a third metal layer, a third insulating layer, a pixel electrode layer, and an upper electrode layer patterned and selectively formed above the substrate.

29. The display device according to claim 28, wherein each of the pixel units further comprises:
a pixel structure, comprising the equivalent bootstrap capacitor formed by the first metal layer, the first insulating layer, the second metal layer, the second insulating layer, the third metal layer, the third insulating layer, and the pixel electrode layer.

30. The display device according to claim 29, wherein the pixel structure further comprises:
a first through hole, formed among the second metal layer, the second insulating layer, the planarization layer, and the third metal layer; and
a second through hole, formed among the first metal layer, the first insulating layer, and the second metal layer.

31. The display device according to claim 30, wherein the pixel structure further comprises:
a third through hole, formed among the third metal layer, the third insulating layer, and the pixel electrode layer.

32. The display device according to claim 30, wherein each of the pixel units further comprises:
a connection pad structure, comprising:
a fourth through hole, formed among the pixel electrode layer, the third insulating layer, and the third metal layer;
a fifth through hole, formed among the third metal layer, the second insulating layer, and the second metal layer; and
a sixth through hole, formed among the second metal layer, the first insulating layer, and the first metal layer.
